(19) United States
(12) Patent Application Publication
(10) Pub. No.: US 2005/0162680 A1
(43) Pub. Date: Jul. 28, 2005

(54) Communication apparatus for forming and outputting image data on the basis of received data

(75) Inventors: Kenzo Sekiguchi, Tokyo (JP); Toru Maeda, Tokyo (JP); Ritsushi Tanabe, Kanagawa-ken (JP); Kotaro Yamaguchi, Kanagawa-ken (JP); Hiroyuki Yaguchi, Tokyo (JP); Kenji Aiyama, Kanagawa-ken (JP); Tomohiro Akiba, Shizuoka-ken (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/091,499

(22) Filed: Mar. 29, 2005

Related U.S. Application Data
(62) Division of application No. 09/419,246, filed on Oct. 15, 1999.

(30) Foreign Application Priority Data
Oct. 16, 1998 (JP) 10-295931

(51) Int. Cl. G06F 15/00

(52) U.S. Cl. 358/1.13; 358/448

(57) ABSTRACT

To achieve the above objects, a communication apparatus for forming and outputting image data on the basis of data received via a network analyzes the contents of received electronic mail and extracts binary data encoded using character codes. The communication apparatus converts the extracted binary data into image data and outputs the data. The communication apparatus requests, where necessary, a server apparatus on the network to convert the binary data into the image data. If the conversion from the binary data into the image data is impossible, the communication apparatus reports this information to the source of the electronic mail in the same session as the electronic mail. The communication apparatus also generates a message from the reported information and transmits the message as electronic mail in a session other than the electronic mail.

### BACKGROUND OF THE INVENTION

1. Field of the Invention

The present invention relates to a communication apparatus capable of exchanging information between electronic information media such as electronic mail and word processor information and facsimile media.

2. Description of the Related Art

Recently, with the spread of PCs (Personal Computers) introduced into offices and homes, the number of PCs connected to LANs and the Internet is abruptly increasing, and consequently the population using electronic mails and WWW (World Wide Web) is dramatically increasing. At the end of 1997, the number of users using the Internet exceeded 60,000,000, and the rate of increase is 100% or more per year. This shows the advent of age in which in addition to transmitting means, represented by a facsimile apparatus, for exchanging electronic paper information using telephone lines, electronic data such as word processor documents and spreadsheet documents to be handled by computers can also be exchanged via LANs and the Internet.

As for a facsimile apparatus as a representative apparatus for transmitting conventional document information, the ratio of facsimile introduction to offices in Japan exceeded 90%, indicating that the market has ripened. However, the production of home facsimile apparatuses shows a great growth tendency. That is, the present day is the age in which information transmission using electronic data and information transmission by facsimile (paper) coexist.

With this age as a background, the rasterization of a facsimile apparatus or communication service as a contact between electronic data information transmission and facsimile information transmission is being sought. This is an apparatus or service called, e.g., Internet FAX that uses a facsimile apparatus as a document reader, converts read facsimile image data into electronic data such as electronic mail, and transmits this electronic data to another Internet FAX apparatus, PC, or facsimile apparatus via a LAN, the Internet, or a public telephone line.

Conventionally, electronic data handled by Internet FAX (apparatus or communication service) is exchanged between apparatuses as electronic mail data based upon an electronic mail data format called MIME (Multipurpose Internet Mail Extensions) recommended by IETF (Internet Engineering Task Force), which is formed by converting facsimile image data into TIFF (Tagged Image File Format) as one image file format and embedding it into electronic mail data. TIFF is image data, rather than general word processor document data or spreadsheet document data.

The abovementioned conventional Internet FAX (apparatus or communication service; the same shall apply hereinafter) exchanges facsimile image data using TIFF by embedding it into electronic mail. Therefore, when non-image data such as a word processor document or a spreadsheet document formed by a PC is added by electronic mail software on the PC and sent to Internet FAX, the receiving Internet FAX cannot interpret the data, such as a word processor document or a spreadsheet document, that is handled by the application software on the PC. Consequently, a printer of the Internet FAX cannot automatically print out the data, or it is impossible to convert the added data into facsimile image data and simply and rapidly send the data to a remote facsimile apparatus. These problems are summarized as follows.

(1) Cumbersome and Time-Consuming Operations

That is, when a PC user wishes to send a word processor document or a spreadsheet document to Internet FAX, he or she must perform complicated operations of once converting the document into image data to form a TIFF file on the PC and then adding this TIFF file to electronic mail.

(2) Large Data Size

If a user desires printing quality substantially equivalent to printing of a word processor document or a spreadsheet document on a PC, it is necessary to rasterize the document into image data with a resolution of about 400 DPI when a printer of the user has 400 DPI. In this case, the data size (quantity) of a TIFF file of the word processor document is obviously larger than the data size of the word processor document. This increases not only the communication time but also the traffic on a LAN or the Internet. Additionally, although the data size of electronic mail data receivable by an electronic mail server related to an electronic mail transfer system depends upon the settings by the system manager, the upper limit of this data size is about 1 Mbyte to. about 2 Mbytes. Therefore, the smaller the size of electronic mail data to be transmitted, the higher the possibility that the data is reliably transmitted to the destination. Also, a TIFF file in Internet FAX and the like contains facsimile image which is already compressed using such as MH, MR, and MMR coding. Therefore, additional file compression achieves little effect.

(3) Unknown Details of Reception Error

If electronic data cannot be normally received on a communication session for receiving the data, the reason of the error is reported using an error code determined by the communication rules. With the recent proliferation of the Internet and the recent technological progress of communication apparatuses, communication apparatuses are beginning to emerge which can process various electronic data such as electronic mails and can handle not only black-and-white images but also multimedia such as color images and sounds. However, it takes a considerable time for a standardization party to stipulate error codes determined by the communication rules. Also, error codes determined by the communication rules cannot completely report detailed information of error, represented by the problem of the receiving capability of receiving media.

Furthermore, messages such as the reasons of transmission errors of electronic data represented by electronic mails are often informed in English. So, it is not easy to understand the contents of these messages.

### SUMMARY OF THE INVENTION

The present invention has been made in consideration of the above situation, and has as its object to improve a communication apparatus.

It is another object of the present invention to provide a communication apparatus for forming and outputting image data on the basis of binary data attached to electronic mail.

It is still another object of the present invention to obviate the need for conversion and the like in attaching data to electronic mail on the sender of the electronic mail.

It is still another object of the present invention to prevent an unnecessary increase in the size of data to be attached to electronic mail and thereby reduce the load on a network.

It is still another object of the present invention to inform, in readily understandable form, a user as a source of electronic mail of a message pertaining to error information of the electronic mail.

To achieve the above objects, a communication apparatus for forming and outputting image data on the basis of data received via a network analyzes the contents of received electronic mail and extracts binary data encoded using character codes. The communication apparatus converts the extracted binary data into image data and outputs the data.

The communication apparatus requests, where necessary, a server apparatus on the network to perform the conversion from the binary data into the image data.

If the conversion from the binary data into the image data is impossible, the communication apparatus reports this information to the source of the electronic mail in the same session as the electronic mail.

The communication apparatus also generates a message from the reported information and transmits the message as electronic mail in another session than the electronic mail.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing the overall arrangement of a communication apparatus according to the present invention;

FIG. 2 is a view showing the front external appearance of the communication apparatus according to the present invention;

FIG. 3 is a view showing the external appearance of an operation unit;

FIG. 4 is a block diagram of a scanner image processor;

FIG. 5 is a block diagram of a printer image processor;

FIG. 6 is a block diagram of an image compressor/expander;

FIG. 7 is a block diagram of an image rotator;

FIG. 8 is a view for explaining an image rotating process;

FIG. 9 is a view for explaining the image rotating process;

FIG. 10 is a block diagram of a device I/F unit;

FIG. 11 is a view showing the arrangement of a network system;

FIG. 12 is a view showing the contents of electronic mail data;

FIG. 13 is a view showing the data structures of electronic data management tables;

FIG. 14 is a sequence diagram pertaining to a data converting process and a document type after the conversion;

FIG. 15 is a sequence diagram of an electronic mail communication procedure;

FIG. 16 is a schematic flow chart of an electronic data receiving process;

FIG. 17 is a flow chart of an electronic data delimiting process;

FIG. 18 is a flow chart of the electronic data delimiting process;

FIG. 19 is a flow chart of the electronic data delimiting processing;

FIG. 20 is a flow chart of the electronic data delimiting process;

FIG. 21 is a flow chart of a content type analyzing process;

FIG. 22 is a state transition diagram;

FIGS. 23 to 30 are flow charts of a divided document converting process;

FIGS. 31 to 33 are flow charts of a converting process;

FIG. 34 is a diagram of a document rasterization request protocol sequence;

FIG. 35 is a diagram of a rasterized document transfer protocol sequence;

FIG. 36 is a flow chart of a printing process; and

FIG. 37 is a view showing an example of an error report.

### DETAILED DESCRIPTION OF THE PREFERRED EMBODIMENT

The present invention will be described in more detail below with reference to the accompanying drawings. The following explanation will be made by taking a hybrid machine having a network interface and including a copying function and a FAX function as an example of a communication apparatus according to the present invention. However, the present invention can naturally be constituted by an apparatus having another arrangement.

(Hardware Arrangement)

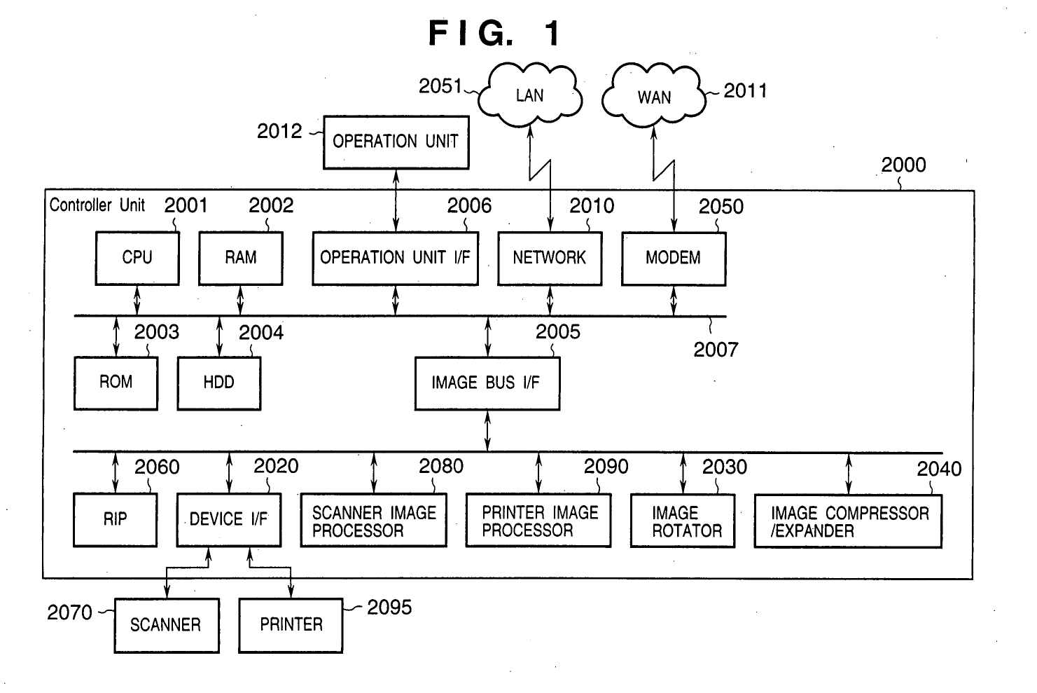

FIG. 1 shows the overall arrangement of the hybrid system. A controller 2000 is connected to a scanner 2070 as an image input device and a printer 2095 as an image output device. This controller 2000 is also connected to a LAN 2011 and a wide area network (WAN) 2051 to input and output image information and device information. A CPU 2001 is a general-purpose processor for controlling the whole hybrid machine. A RAM 2002 is a system working memory with which the CPU 2001 operates. This RAM 2002 is also an image memory for temporarily storing image data. A ROM 2003 is a boot ROM storing the boot program of the hybrid machine. An HDD 2004 is a hard disk drive storing system software and image data. An operation unit I/F 2006 is an interface with an operation unit (UI) 2012 and outputs, to the operation unit 2012, image data to be displayed on the operation unit 2012. The operation unit I/F 2006 also transfers information input by the user of this system to the CPU 2001. A modem 2050 connects with the WAN 2051 and inputs and outputs information. These devices are arranged on a system bus 2007.

An image bus I/F 2005 is a bus bridge which connects the system bus 2007 to an image bus 2008 for transferring image data at high speed and converts the data structure. The image bus 2008 is constructed of a PCI bus or an IEEE 1394. The following devices are arranged on this image bus 2008. A network I/F 2010 connects the system bus 2007 to the LAN 2011 and inputs and outputs information. A raster image processor (RIP) 2060 rasterizes PDL (Page Description Language) codes into a bit map image. A device I/F unit 2020 connects the scanner 2070 and the printer 2095 as image input/output devices to the controller 2000 and performs synchronous system/asynchronous system conversion of image data. A scanner image processor 2080 corrects, processes, and edits input image data. A printer image processor 2090 corrects the printer and converts the resolution of the printer with respect to printed image data. An image rotator 2030 rotates image data. An image compressor/expander 2040 performs JPEG for multi-valued image data and JBIG, MMR, or MH for binary image data as a compressing/expanding process.

The arrangement as described above is separated into a system bus 207 section and the image bus 2008 section by considering the extensibility of the image processing portion. That is, a general computer configuration is applied. In the above arrangement, a general-purpose I/F is used as the image bus I/F to improve the degree of freedom with which arbitrary image processing activities can be combined, and to improve the extensibility in the future. In particular, various standards may be proposed in the future for the image compressing/expanding portion, so this portion is connected to the image bus side so as to be readily exchangeable.

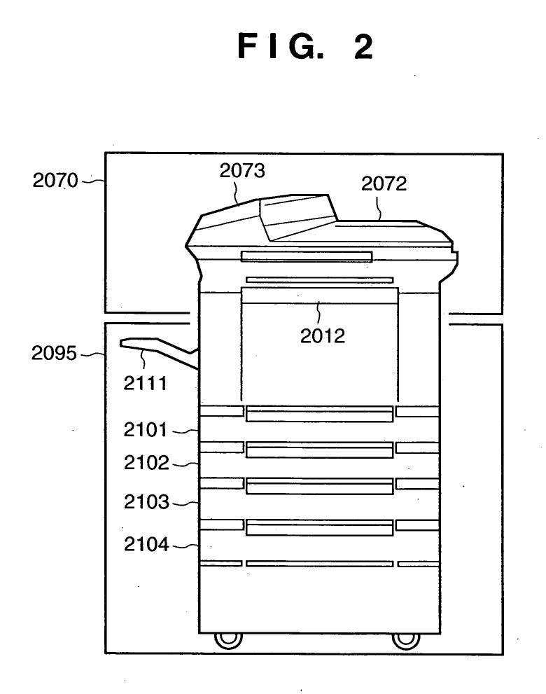

FIG. 2 shows the front external appearance of the composite system. The scanner unit 2070 as an image input device illuminates an original and scans a CCD line sensor (not shown) to convert into an electrical signal as raster image data. Originals are set in a tray 2073 of an original feeder 2072. When the user inputs a reading activation instruction from the operation unit 2012, the controller CPU 2001 gives the instruction to the scanner 2070, and the feeder 2072 feeds originals one by one to read original images.

The printer unit 2095 as an image output device converts raster image data 2096 into an image on a recording medium such as a paper sheet. Examples of the system are an electrophotographic system using a photosensitive drum or a photosensitive belt and an ink jet system which forms images directly on a sheet by ejecting ink from a fine nozzle array, and any system can be used. Printing is started by an instruction from the controller CPU 2001. The printer unit 2095 has a plurality of supply stages so that different recording medium sizes or different recording medium directions can be selected, and has corresponding cassettes 2101, 2102, 2103, and 2104. A paper delivery tray 2111 receives printed recording media.

Operation Unit

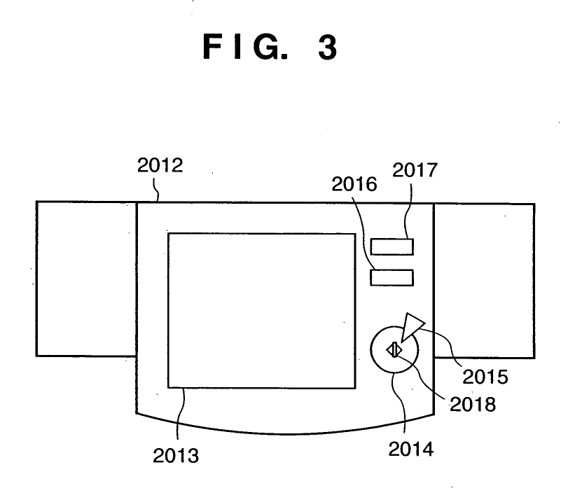

FIG. 3 shows the external appearance of the operation unit 2012. A touch panel sheet is pasted on an LCD of an LCD display unit 2013. This LCD display unit 2013 displays a system operation screen and, when a key displayed on the screen is pressed, transmits the corresponding position information to the controller CPU 2001. A start key 2014 is used to start reading an original image. Green and red LEDs 2018 are attached to the center of the start key 2014 and indicate whether the start key 2014 is usable by their respective colors. A stop key 2015 has a function of stopping an operation currently being executed. An ID key 2016 is used to input the user ID of the user. A reset key 2017 is used to initialize settings from the operation unit.

Scanner Image Processing Unit

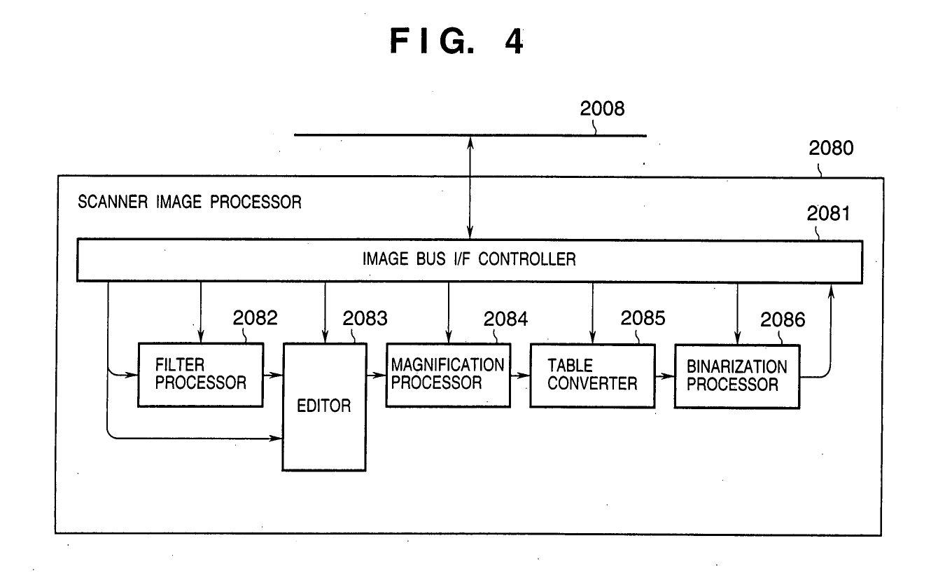

FIG. 4 shows the arrangement of the scanner image processor 2080. An image bus I/F controller 2081 connects with the image bus 2008 to control its bus access sequence, controls individual devices in the scanner image processing unit 2080, and generates timings of these devices. A filter processor 2082 is a spatial filter and performs convolution arithmetic operations. An editor 2083 finds a closed region surrounded by a marker pen from input image data and performs image processing, such as shading, halftoning, or negative-to-positive inversion, for the image data in the closed region. A magnification processor 2084 performs interpolation arithmetic operations in a main scan direction of a raster image to enlarge or reduce the image, when the resolution of the read image is to be changed. The magnification in a sub-scan direction is changed by changing the rate at which an image read line sensor (not shown) is scanned. A table converter 2085 performs table conversion for converting image data as read luminance data into density data. A binarization processor 2086 binarizes multi-valued gray scale image data by an error diffusion process or a screen process.

The processed image data is again transferred onto the image bus via the image bus controller 2081.

Printer Image Processor

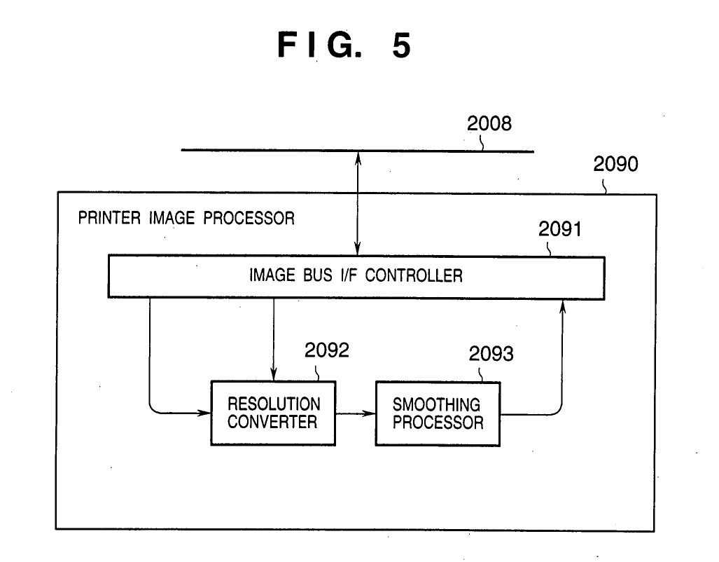

FIG. 5 shows the arrangement of the printer image processor 2090. An image bus I/F controller 2091 connects with the image bus 2008 to control its bus access sequence, controls individual devices in the printer. image processor 2090, and generates timings of these devices. A resolution converter 2092 converts the resolution of image data received from the LAN 201 or the WAN 2051 into the resolution of the printer 2095. A smoothing processor 2093 smoothes jaggy (staircasing appearing in a black-to-white boundary such as an oblique line) of the resolution-converted image data.

Image Compressor/Expander

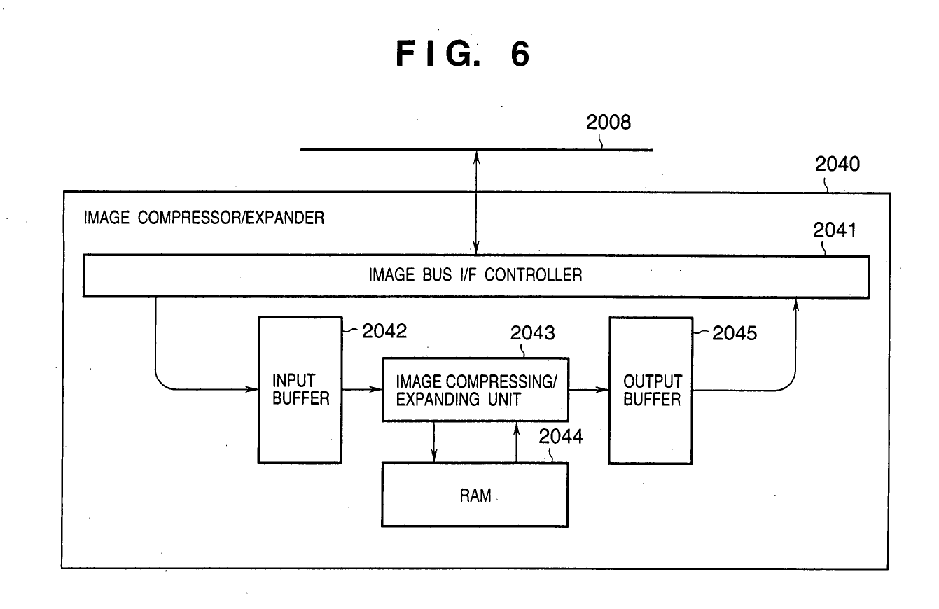

FIG. 6 shows the arrangement of the image compressor/expander 2040. An image bus I/F controller 2041 connects with the image bus 2008 to control its bus access sequence, controls timings of data exchange with an input buffer 2042 and an output buffer 2045, and controls mode settings for an image compressing/expanding unit 2043. In the present invention, data compression is handled as encoding, and data expansion is handled as decoding. The procedure of this image compressor/expander will be described below.

The CPU 2001 performs setting for image compression control in the image bus I/F controller 2041 via the image bus 2008. By this setting, the image bus I/F controller 2041 performs setting (e.g., MMR compression or JBIG expansion) necessary for image compression for the image compressing/expanding unit 2043. After the necessary setting, the CPU 2001 permits the image bus I/F controller 2041 to transfer image data. In accordance with this permission, the image bus I/F controller 2041 starts transferring image data from the RAM 2002 or from any device on the image bus 2008. The input buffer 2042 temporarily stores the received image data and transfers the image at a constant speed in accordance with an image data request from the image compressing/expanding unit 2043. During this transfer, the input buffer checks whether image data transfer is possible between the image bus I/F controller 2041 and the image compressing/expanding unit 2043. If the image data read from the image bus 2008 or the image write to the image compressing/expanding unit 2043 is impossible, the input buffer performs control (to be referred to as a handshake hereinafter) so that no data transfer is performed.

The image compressing/expanding unit 2043 temporarily stores the received image data into a RAM 2044. This is because when image compression is to be performed, data of several lines is necessary depending on the type of image compressing process, and the first line cannot be compressed unless the image data of several lines is prepared. The compressed image data is immediately transferred to the output buffer 2045. The output buffer 2045 handshakes with. the image bus I/F controller 2041 and the image compressing/expanding unit 2043, and transfers the image data to the image bus I/F controller 2041. The image bus I/F controller 2041 transfers the transferred compressed (or expanded) image data to the RAM 2002 or to any device on the image bus 2008. The series of these processes are repeated until no further process request is output from the CPU 2001 (when the necessary number of pages are completely processed), or until this image compressor/expander outputs a stop request (e.g., when error occurs during compression or expansion).

Image Rotator

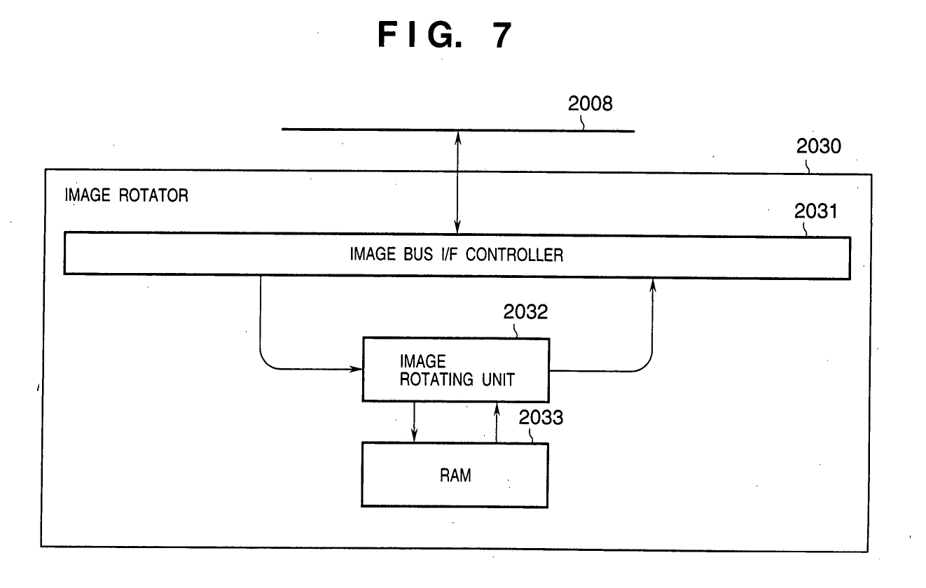

FIG. 7 shows the arrangement. of the image rotator 2030. An image bus I/F controller 2031 connects with the image bus 2008 to control its bus sequence, sets a mode and the like in an image rotating unit 2032, and controls timings for transferring image data to the image rotating unit 2032. The procedure of this image rotator will be described below.

The CPU 2001 performs setting for image rotation control in the image bus I/F controller 2031 via the image bus 2008. By this setting, the image bus I/F controller 2031 performs setting (e.g., the image size and the direction and angle of rotation) necessary for image rotation in the image rotating unit 2032. After the necessary setting, the CPU 2001 permits the image bus I/F controller 2031 to transfer image data. In accordance with this permission, the image bus I/F controller 2031 starts transferring image data from the RAM 2002 or from any device on the image bus 2008. Assume that the width of the image bus 2008 is 32 bits, the image size for rotation is 32×32 (bits), and image data is transferred to the image bus 2008 in units of 32 bits (images to be handled are binary images).

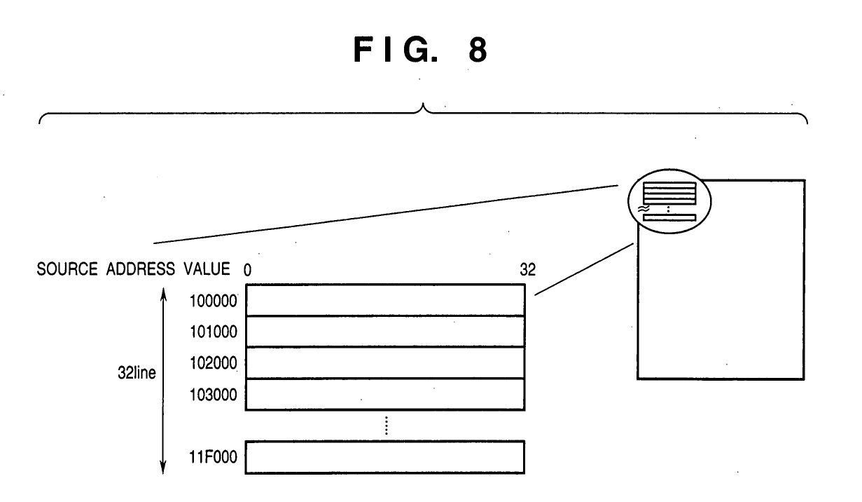

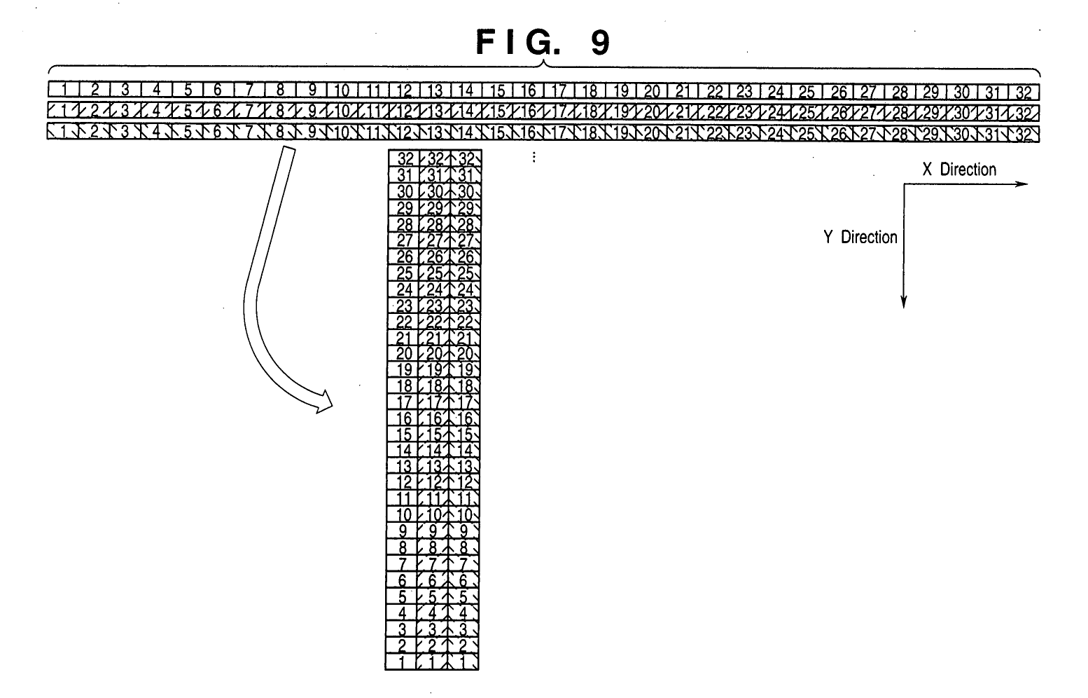

To obtain an image of 32×32 (bits) as described above, it is necessary to perform the aforementioned unit data transfer 32 times and transfer image data from discontinuous addresses (FIG. 8). The image data transferred by discontinuous addressing is written in the RAM 2033 so that the data is rotated through a desired angle when read out. For example, in 90° counterclockwise rotation, 32-bit image data transferred first is written in a Y direction as shown in FIG. 9. The image is rotated as it is read out in an X direction.

When the 32×32 (bits) image rotation (write to the RAM 3032) is complete, the image rotating unit 2032 reads out the image data by the abovementioned reading method and transfers the image to the image bus I/F controller 2031.

The image bus I/F controller 2031 that has received the rotated image data transfers the data to the RAM 2002 or to any device on the image bus 2008 by discontinuous addressing. The series of these processes are repeated until no further process-request is output from the CPU 2001 (when the necessary number of pages are completely processed).

Device I/F Unit

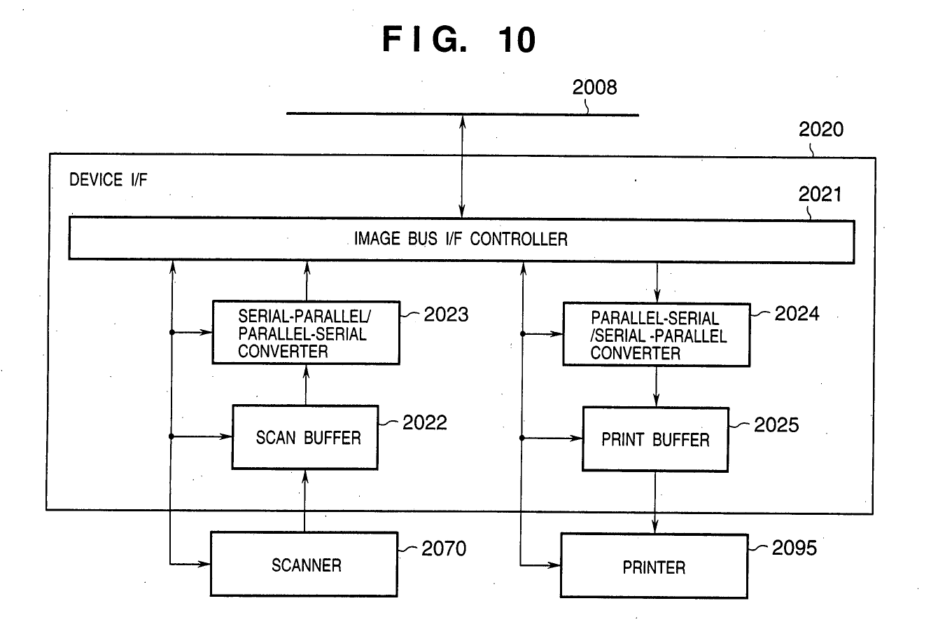

FIG. 10 shows the arrangement of the device I/F unit 2020. An image bus I/F controller 2021 connects with the image bus 2008 to control its bus access sequence, controls individual devices in the device I/F unit 2020, and generates timings of these devices. The image bus I/F controller 2021 also generates control signals to the external scanner 2070 and the printer 2095. A scan buffer 2022 temporarily stores image data supplied from the scanner 2070 and outputs the image data in synchronism with the image bus 2008. A serial-parallel/parallel-serial converter 2023 arranges in order, or decomposes, the image data stored in the scan buffer 2022, thereby converting into the data width of image data transferable to the image bus 2008. A parallel-serial/serial-parallel converter 2024 decomposes, or arranges in order, the transferred image data from the image bus 2008, thereby converting into the data width of image data storable in a print buffer 2025. The print buffer 2025 temporarily stores image data supplied from the image bus 2008 and outputs the image data in synchronism with the printer 2095.

The procedure of image scan will be described below. Image data supplied from the scanner 2070 is stored in the scan buffer 2022 in synchronism with a timing signal from the scanner 2070. If the image bus 2008 is a PCI bus, when 32 bits or more of the image data are stored in the buffer, 32 bits of the image data are transferred, in a first-in first-out manner, from the buffer to the serial-parallel/parallel-serial converter 2023. This image data is converted into 32-bit image data which is in turn transferred onto the image bus 2008 via the image bus I/F controller 2021. If the image bus 2008 is an IEEE 1394, the image data in the buffer is transferred, in a first-in first-out manner, from the buffer to the serial-parallel/parallel-serial converter 2023. This image data is converted into serial image data which is,in turn transferred onto the image bus 2008 via the image bus I/F controller 2021.

The procedure of image printing will be described below. If the image bus 2008 is a PCI bus, the image bus I/F controller receives 32-bit image data supplied from the image bus and transfers the image data to the parallel-serial/serial-parallel converter 2024. This image data is decomposed into image data having the number of input data bits of the printer 2095, and the decomposed data is stored in the print buffer 2025. If the image bus is an IEEE 1394, the image bus I/F controller receives serial image data supplied from the image bus and transfers the image data to the parallel-serial/serial-parallel converter 2024. This image data is decomposed into image data having the number of input data bits of the printer 2095, and the decomposed data is stored in the print buffer 2025. In synchronism with. a timing signal supplied from the printer 2095, the image data in the buffer is transferred to-the printer 2095 in a first-in first-out manner.

(System Configuration)

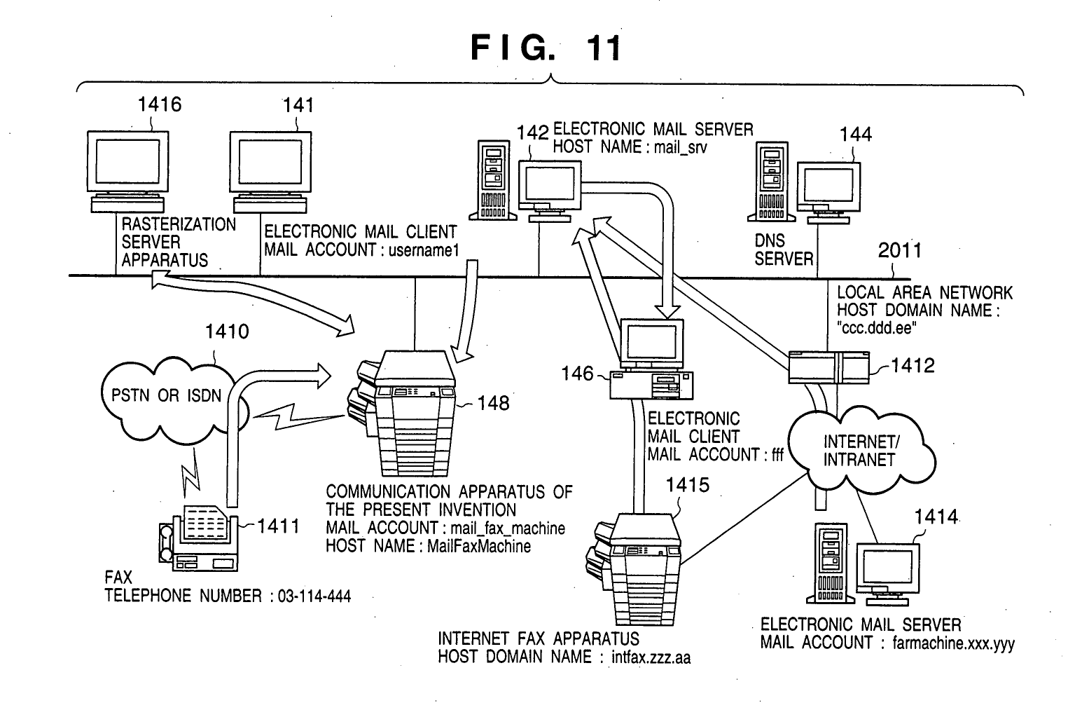

FIG. 11 is a view of a network system configuration showing a connection relationship and data exchange between devices when the communication apparatus of this embodiment is connected to other devices.

A communication apparatus 148 is connected to electronic mail clients 141 and 146, a local electronic mail server 142, a DNS server 143, and a rasterization server apparatus 1416 via the LAN 2011. A router 1412 is connected to the LAN 2011. Via this router 1412, the communication apparatus 148 can communicate with a remote electronic mail server 1414 and an Internet FAX apparatus 1415 connected to another network such as an Internet/Intranet 1413. The communication apparatus 148 can also communicate with a FAX apparatus 1411 via a public line 1410, such as PSTN (Public Switching Telephone Network)/ISDN, in addition to the LAN 2011.

Electronic mail transmitted to the communication apparatus 148 from the remote electronic mail server 1414 or the electronic mail client 141 or 146 is received by the local electronic mail server 142 and transferred to the communication apparatus 148. If the electronic mail data received by the communication apparatus 148 contains an attached file which can be rasterized only by the rasterization. server apparatus 1416, the communication apparatus 148 requests the rasterization server apparatus 1416 to convert binary data of this attached file into data (e.g., TIFF binary data, binary data encoded by ITU-T recommendation T.4 or image data encoded by a predetermined encoding method such as JPEG etc) of a format which can be handled by the communication apparatus 148. Details of the communication between the rasterization server apparatus 1416 and the communication apparatus 148 will be described later.

(Software)

The operation of this embodiment will be described below.

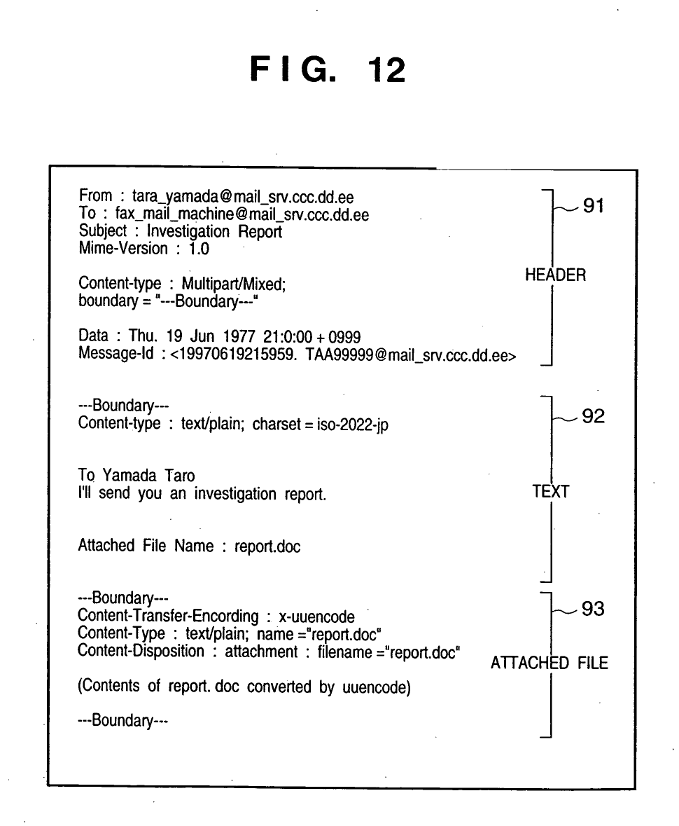

FIG. 12 is a view showing an example of electronic mail data to which non-image data, such as a word processor document or a spreadsheet file is attached as an attached file. That is, FIG. 12 shows the contents of electronic mail data described in MIME format.

As shown in FIG. 12, this electronic mail data is composed of a header part 91 in which a source, a destination, a title, and type (style) information of mail are described, a text part 92 in which a mail document is described, and an attached file part 93 in which encoded electronic data is described. These parts are delimited by characters ( - - - Boundary - - - in FIG. 12) indicating boundaries. In a header portion (part start portion) of each part, character code information, an encoding method, and the file name of the part are described.

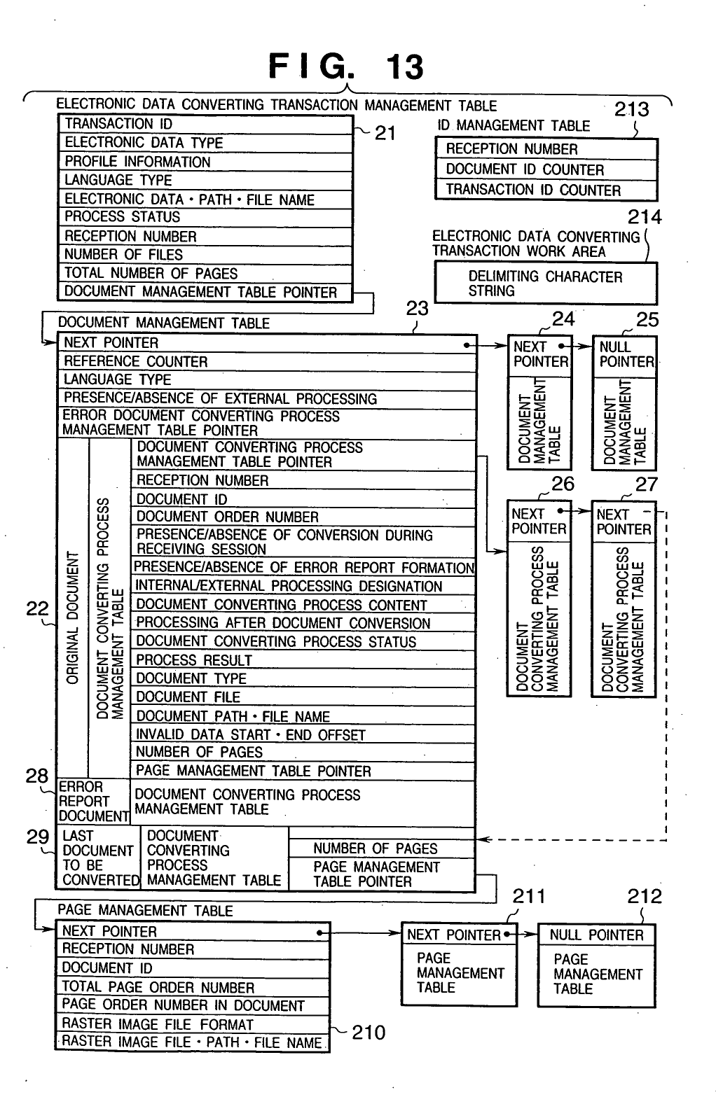

FIG. 13 is a view showing the data structures of electronic data management tables used in storage, conversion, and printing of electronic data in the communication apparatus of the present invention.

An ID management table 213 has areas of a reception number counter, document ID counter, and transaction ID counter, and generates a reception number, document ID number, and transaction ID number.

An electronic data converting transaction management table 21 is acquired when data of received electronic mail is to be analyzed, and stores the IDs generated by the ID management table 21 and various pieces of information extracted from the header of the electronic mail. A document management table pointer of this electronic data converting transaction management table 21 indicates the start position of a first document management table acquired in the transaction.

Document management tables 23 to 25 are tables obtained for each part of electronic mail data, and have areas for diverse pieces of information set in accordance with the contents of each part. Each document management table has a next point area for indicating the start position of a document management table corresponding to the next part. This next point area is a NULL pointer in a document management table (25) corresponding to the final part. Each document management table has an original document area 22, an error report document area 28, and a last document to be converted area 29.

Page management tables 210 to 212 have, as will be described later, an area for storing information necessary to manage received rasterized document data. Similar to the document management tables, these page management tables are linked by pointer areas.

These tables are stored and rasterized, where necessary, in a device such as the RAM 2002 or the HDD 2004 that the CPU 2001 can read and write.

When reception of electronic data (particularly electronic mail) from the LAN 2001 or the WAN 2051 is started, the CPU 2001 acquires (an area of) the electronic data converting transaction management table 21 in a specific area of the HDD 2004 or the RAM 2002. Simultaneously, the value of the “transaction ID counter” area in the ID management table 213 is incremented and set in the “transaction ID” area of the electronic data converting transaction management table 21. Analogously, the value of the “reception number counter” area in the ID management table 213 is incremented and set in the “reception number” area of the electronic data converting transaction management table 21.

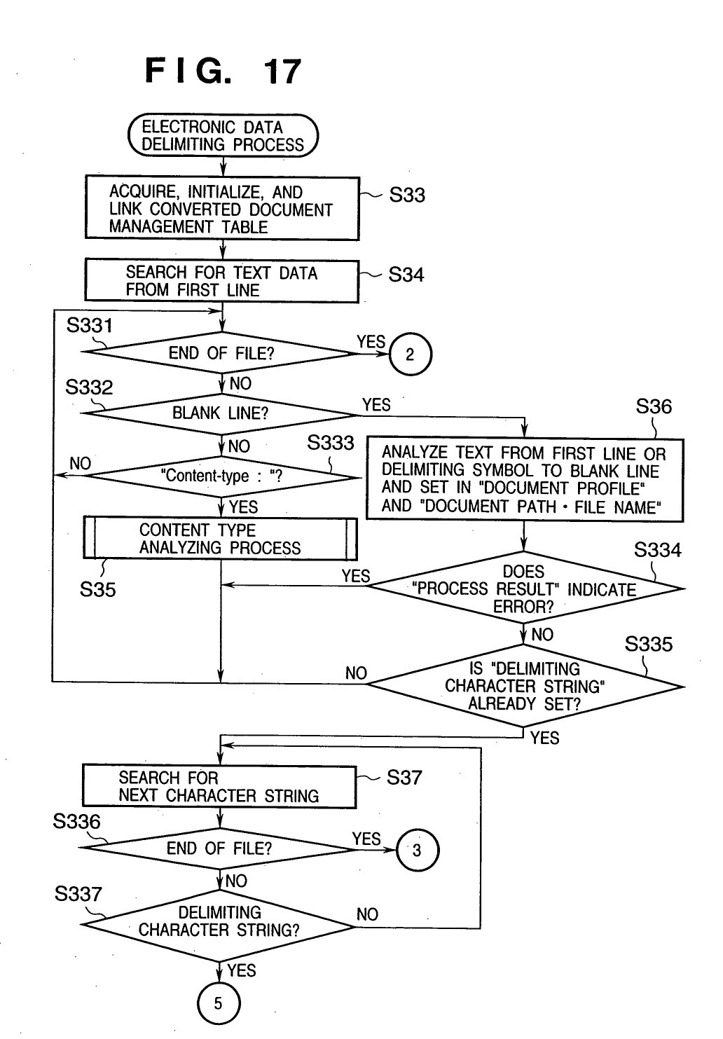

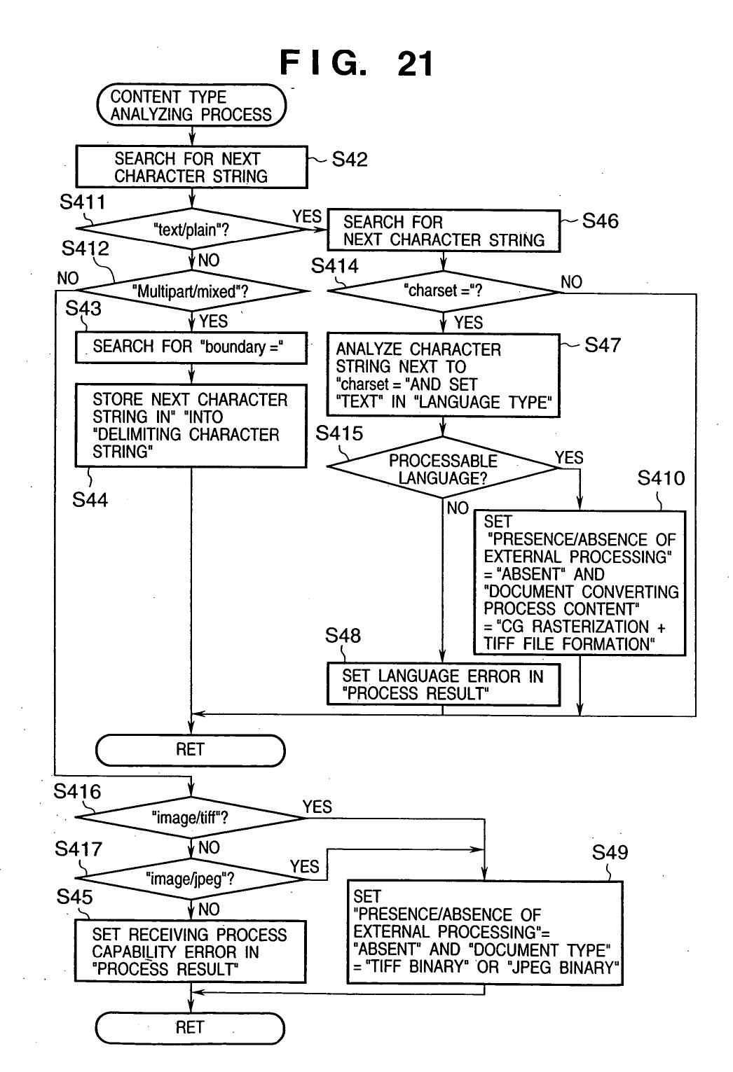

Multimedia data of electronic mail described in MIME as shown in FIG. 12 is divided or broken up in units of media segments by an electronic data delimiting process (FIGS. 17 to 20) and a content type analyzing process (FIG. 21). The document management tables 23, 24, and 25 corresponding to these media segments are acquired. While data is set in these tables, a queue of document management tables starting from the “document management table pointer” in the electronic data converting transaction management table 21 is formed. Information concerning each segment data is set around the “original document” area 22 in the document management table.

The operation will be described by taking the mail shown in FIG. 12 as an example. The header part 91 is linked as the first document management table 23. “Text” is set in the “document type” area of this table, and “ASCII” is set in the “language type” area of the table.

The text part 92 of the mail is linked as the second document management table 24. “Text” is set in the “document type” area of this table, and “Japanese S-JIS” is set in the “language type” area of the table. The remaining attached file part 93 is linked as the third document management table 25. “Encoded text” representing data obtained by encoding binary codes such as UUENCODE into text is set in the “document type” area of this table.

Whenever a new document management table is acquired, the value of the “document ID counter” area is incremented and set in the “document ID” area of the acquired document management table. Simultaneously, the value of the “reception number” area in the electronic data converting transaction management table 21 is copied to the “reception number” area. Also, a value incremented in order from 1 each time a management table is acquired is set in the “document order number” area of the document management table.

In a “presence/absence of conversion during receiving session” area of the document management table, “convert” and “do not convert” can be switched for each of various converting processes during reception in accordance with the time of a converting process such as conversion of image data of received data during reception, and with the allowable time from completion of the reception of the received data to return of a response in the receiving session.

Accordingly, optimization can be readily performed by using, e.g., system parameters in accordance with the allowable time of response to the received data during the receiving session.

Additionally, by only setting information “form” or “do not form” in a “presence/absence of error report formation” area of the document management table, whether an error report (character string or image data) is to be formed can be easily changed.

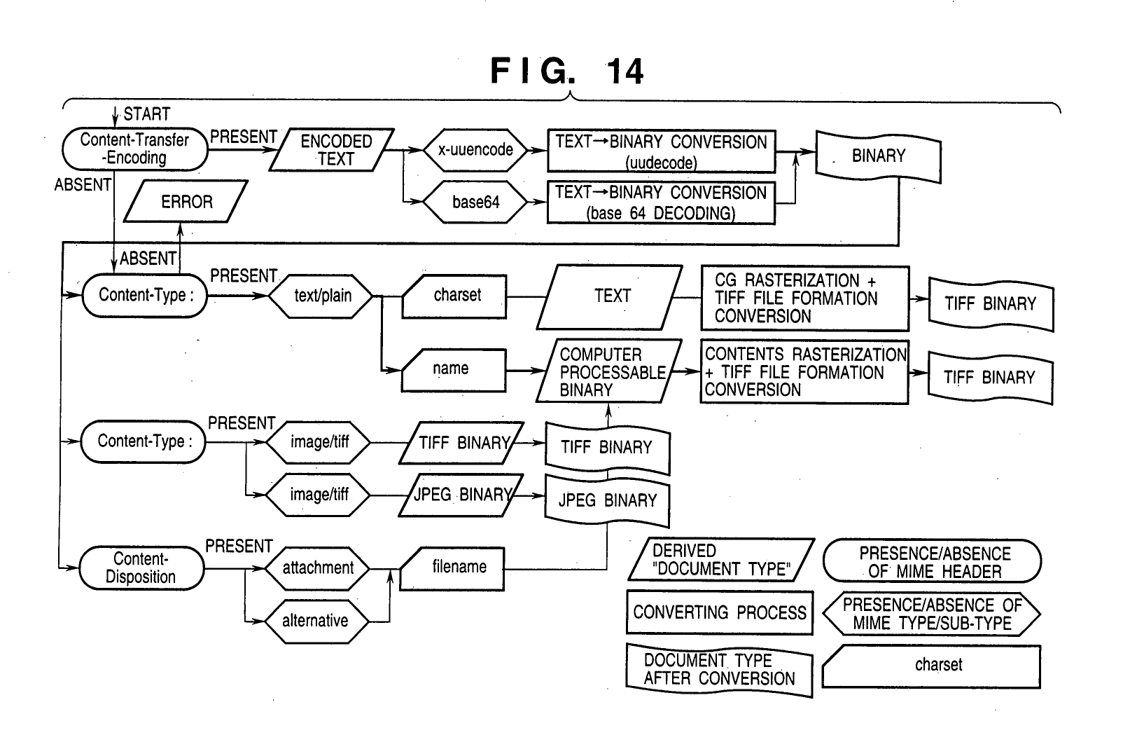

FIG. 14 is a sequence diagram pertaining to a data converting process and the document type after the conversion. This data converting process is necessary to discriminate the data contents of the electronic mail data in FIG. 12, determine the document type, and output the data from the printing device of this communication apparatus or perform FAX transmission or the like.

The process flow in the present invention will be described below with reference to FIGS. 12 and 14.

The flow starts from “START”. Since data “Content-Transfer-Encoding” exists in the attached file part 93 of the electronic mail data, the “document type” of the attached film part 93 is discriminated as “encoded text”. Also, “x-uuencode”, “Content-Type”, “text/plain”, and “name” exist in this attached file part. Hence, to finally print out the data in the communication apparatus of the present invention, the following process flow is necessary:
1) Convert “contents of report doc encoded by uuencode” as text data of the attached file part 93 into binary data by uudecode.
2) Print out by word processor software on the rasterization server apparatus and convert into “TIFF binary” data interpretable by the communication apparatus of the present invention by a printer driver on the rasterization server apparatus.
3) Transmit the “TIFF binary” data to the communication apparatus of the present invention from the rasterization server apparatus.
   If a file of another type is attached, e.g., if the attached file part 93 contains data formed by converting an image file such as JPEG into text, necessary processing is performed on the basis of information of the MIME header. Details of the sequence view shown. in FIG. 14 will be described later in the explanation of the data delimiting process shown in FIGS. 17 to 20.

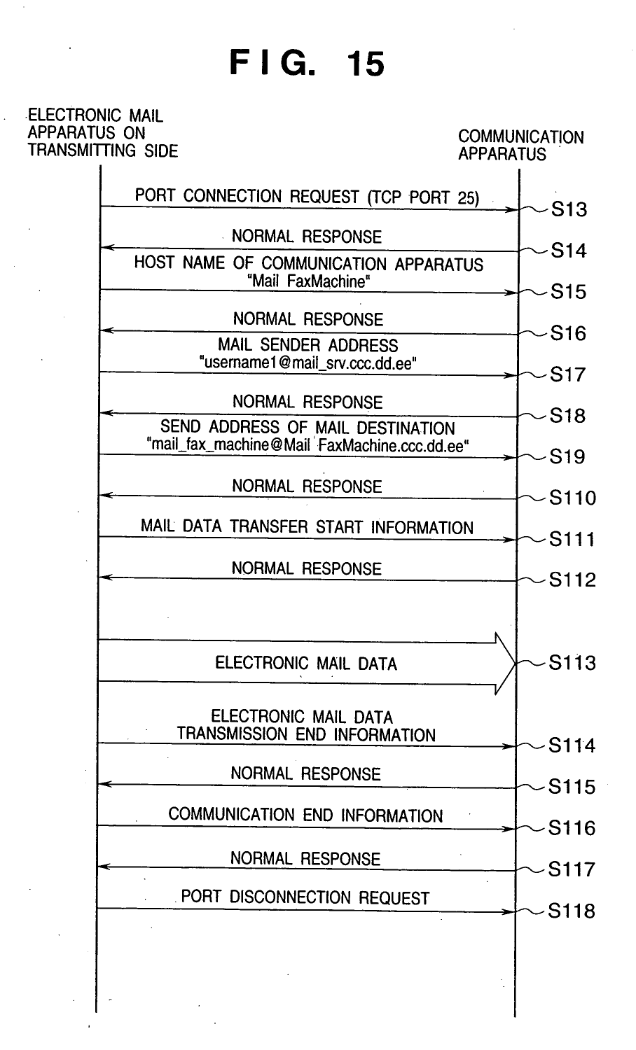

FIG. 15 is a diagram showing a protocol sequence when in the network configuration shown in FIG. 11, the communication apparatus 148 of this embodiment receives electronic mail sent by the electronic mail account 141 from an electronic mail apparatus such as the local electronic mail server 142. In this embodiment, transmission and reception of electronic mails are done by SMTP (Simple Mail Transfer Protocol).

First, the electronic mail apparatus transmits a connection request to the communication apparatus by using the port number 25 as a listener port of SMTP (S13). When receiving this connection request, the communication apparatus activates an electronic mail receiving process as an SMTP demon for electronic mail reception, and returns a normal response (S14). Then the electronic mail apparatus transmits the host name (“MailFaxMachine”) of the communication apparatus (S15). If the received host name is in agreement with the host name assigned to the communication apparatus, the communication apparatus returns a normal response (S16).

The electronic mail apparatus transmits the sender address (“username1@mail_srv.ccc.dd.ee”) of electronic mail (S17). Upon receiving the address, the communication apparatus returns a normal response (S18). In response to this, the mail apparatus transmits the destination address (“mail_fax_machine@MailFaxMachine.ccc.dd.ee”) of the mail (S19). The communication apparatus checks whether the destination is this communication apparatus and mail transfer is unnecessary. Since transfer is unnecessary in this example, the communication apparatus returns a normal response to the mail apparatus (S110).

Next, the electronic mail apparatus transmits mail data transfer start information (S111). When receiving this information, the communication apparatus performs operations such as initialization necessary for electronic mail reception and returns a normal response (S112). In response to this, the mail apparatus transmits electronic mail data (S113) and, when the transmission is over, subsequently transmits electronic mail transmission end information (S114). When receiving this end information, the communication apparatus performs terminating work, e.g., closes the reception file of the electronic mail data, and returns a normal response (Sll5).

If the number of mails to be transmitted is one, the mail apparatus transmits transmission end information (S116). When receiving a normal response (S117.) from the communication apparatus, the mail apparatus transmits a port disconnection request (S118), thereby terminating the mail transmission session.

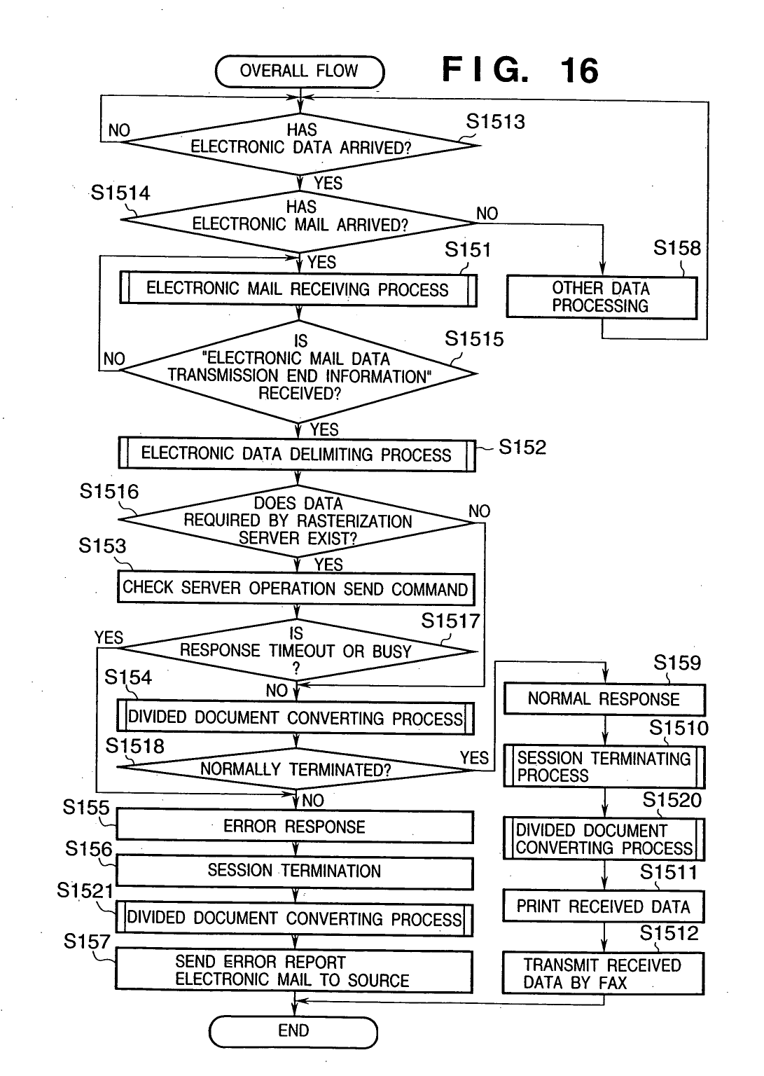

FIG. 16 is a flow chart showing the flow of the whole electronic data receiving procedure, performed by the communication apparatus of the present invention, from electronic data reception to error report mail transmission through conversion and electronic mail data printing.

The overall operation of the communication apparatus of this embodiment will be described below with reference to FIG. 16.

The communication apparatus waits for the arrival of electronic data (S1513). If an external apparatus sends a port connection request by TCP/IP, the communication apparatus discriminates the port number (S1514). If the port number is not 25 (the port number for requesting connection by SMTP), the communication apparatus performs other data processing (S158) and returns to the electronic data arrival waiting state.

Upon receiving the request of connection to the port 25, the communication apparatus executes the aforementioned mail reception protocol sequence (FIG. 15, S14 to S114) (S151). In this receiving process, if the communication apparatus receives the mail data transfer start information (S111), the apparatus secures a file for electronic mail reception and initializes the management table data (e.g., sets the name of the file for electronic mail reception into an “electronic data•path•file name” area of the electronic data converting transaction management table 21). When receiving “.” and carriage as a mail data end delimiter which is the electronic mail data transmission end information (FIG. 15, S114) (S1515), the communication apparatus closes the reception file of the electronic mail data.

Next, the communication apparatus performs an electronic data delimiting process (S152) and checks whether the electronic mail contains data which cannot be rasterized in the communication apparatus and hence requires a rasterization request to the rasterization server (S1516). More specifically, the communication apparatus checks whether “present” is in a “presence/absence of external processing” area of any of the document management table queues 23, 24, and 25 linked from the electronic data converting transaction management table 21 and corresponding to individual parts of the mail data. If data requiring the rasterization server 1416 is found, the communication apparatus links association to the server 1416 by using TCP/IP and sends a “server operation confirmation” command (S153). If a response is received within a defined time and the response is not a “busy response” (S1517), the flow advances to a divided document converting process (S154). If no data requiring the rasterization server is found, the flow directly advances to the divided document converting process (S154).

The communication apparatus then checks whether the divided document converting process terminates normally (S1518). If the process terminates normally, the communication apparatus returns a normal response (FIG. 15, S115), with respect to the electronic mail data transmission end information, to the electronic mail apparatus on the transmission side (S159). The communication apparatus performs a session terminating process (S1510) corresponding to steps S116 to S118 in FIG. 15.

When the mail receiving process is complete, the communication apparatus prints out the received data (S1511). In step S1512, the communication apparatus transmits data formed by converting the received electronic mail data into FAX data to a desired destination by FAX transmission.

As a method of designating the FAX destination from the source, the following methods are possible:

(1) Method of Designating by Header Part

The FAX number of the destination is added to the header part of electronic mail data, e.g., added after the title (Sub:) of the mail. That is, in the electronic mail data shown in FIG. 12, the FAX number is designated like Investigation Report (FAX03-3756-1234). Alternatively, the FAX number is designated like “TO: FAX03-3756-1234@xxxx.yyyy.zzzz” in the destination address. However, when the FAX number is to be designated in the header part, the number must be previously set to prevent the communication apparatus from detecting an error in mail reception.

(2) Method of Designating in Text Part

A description of the telephone number, e.g., “FAXNO =03-3756-1234” is added to the text part 92.

In either method, the number is detected in the electronic data delimiting process in step S151. The detected number is extracted, stored in a predetermined area of the RAM 2002 or the HDD 2004, and read out and used in step S1512.

To extract the number in method (1), a character string “FAX (and numerals)” is extracted from a character string after “Sub:” or “FROM:”. To extract the number in method (2), a line starting from “FAXNO=” is searched for, and a string of numerals following this line is extracted.

On the other hand, if the divided document converting process (S154) terminates abnormally in step S1518, instead of returning a normal response in step S159, the communication apparatus returns error to the electronic mail apparatus as the main source at the timing in step S115 of FIG. 15 (S155). The communication apparatus receives “communication end information” from the electronic mail apparatus (FIG. 15, S116) and returns a response (FIG. 15, S117), thereby terminating the session (S156). After that, the communication apparatus extracts the source address by searching for the pattern “From: aaaaa@xxxx.yyyy.zzzz” from the file recorded in the “electronic data•path•file name” area of the electronic data converting transaction management table 21, and sends electronic mail of the “error report” already formed during the divided document converting process to the source electronic mail address “aaaaa@xxxx.yyyy.zzzz” (S157).

The divided document converting process in step S1520 and S1521 is executed when the document converting process is not completely performed during the received data processing. When the whole converting process is complete, the flow advances to the next step without performing anything.

Details of the electronic data delimiting process shown in step S152 of FIG. 16 will be described with reference to FIGS. 13 and 17 to 20. In the following description, the electronic mail data in MIME format shown in FIG. 12 is reception data.

FIGS. 17 to 20 are flow charts showing details of the electronic data delimiting process.

First, a new document management table 23 is acquired and linked to the “document management table pointer” of the electronic data converting transaction management table 21 (to be referred to as a transaction management table hereinafter). Whenever a new document management table is acquired, the value of the “document ID counter” in the ID management table 213 is incremented and set in the “document ID” area of the acquired document management table. At the same time, the value of an area having the same name in the transaction management table 21 is copied to the “reception number” area in the document management table. Also, a value incremented in order from 1 each time a new management table is acquired is set in the “document order number” area of the document management table.

Next, a file having the name recorded in the “electronic data•path•file” area of the transaction management table 21 is opened, and search is performed line by line from the first line (S34). If both of “end of file?” (S331) and “blank line?” (S332) are NO, whether “Content-Type:” exists in the beginning of the line is checked (S333). If all the check results in steps S331 to S333 are NO, the next line is similarly checked. In the electronic mail data shown in FIG. 12, all the check results in steps S331 to S333 are NO up to the fourth line. Since “Content-Type:” exists in the fifth line, the flow advances to a content type analyzing process (S35) from step S333.

Details of this content type analyzing process will be described below with reference to FIG. 21. FIG. 21 is a flow chart showing details of the content type analyzing process shown in FIGS. 17 to 20. First, a character string following “Content-Type:” in the electronic mail data is searched for (S42). If the character string is “text/plain;” (S411), a character string following this character string is further searched for (S46). If this character string is “charset=” (S414), the next character string is analyzed (S47). Data representing the language type is set in the “language type” area of the corresponding document management table, and “text” is set in the “document type” area in the “original document” area of the same table. If the character string analysis indicates that the language type cannot be determined or the language cannot be processed because there is no corresponding font (S415), “language error” is set in the “process result” area of the document management table (548), and the content type analyzing process is completed.

If the language is processable, “absent” is set in the “presence/absence of external processing” of the document management table and “CG rasterization+TIFF file formation” is set in the “document converting process content” area of the same table (S410), and the content type analyzing process is completed.

If the character string following “Content-Type:” is not “text/plain”, whether this character string is “Mulitpart/Mixed;” is checked (S412). If YES in step S412, “boundary=” is searched for (S43). A character string in double quotation marks (“”) next to “boundary=” is set in the “delimiting character string” area of the electronic data converting transaction work area 214 (S44), and the content type analyzing process is completed.

If NO in steps S42 and S412, i.e., the character string following “Content-Type:” is neither “text/plain;” nor “Multipart/Mixed;”, whether the character string is “image/tiff;” or “image/jpeg;” is checked in steps S416 and S417. If YES in step S416 or S417, “absent” is set in the “presence/absence of external processing” area of the document management table and “TIFF binary” (in the case of “image/tiff;”) or “JPEG binary” (in the case of “image/jpet;”) is set in the “document type” area of the same table (S49), and the content type analyzing process is completed.

If NO in both steps S416 and S417, error is set in the “process result” area of the document management table (S45), and the content type analyzing process is completed.

In this embodiment, the character string following “Content-Type:” in the mail data shown in FIG. 12 is “Multipart/Mixed;”. Therefore, the character string “boundary=” is further searched for in step S43. In step S44, a character string “ - - - Boundary - - - ” in double quotation marks (“”) next to “boundary=” and found on the sixth line is stored as a delimiting character string in the “delimiting character string” area of the electronic data converting transaction work area 214. In this manner, step S35 ends, and the flow returns to processing of the next line.

Next, the ninth line of the mail data is found as a blank line. Therefore, the file position of the header part 91 of the electronic mail data is set in a “valid data start•end offset” area of the “original document area 22 of the corresponding document management table 23. Also, data in the “electronic data•path•file name” of the transaction management table 21 is copied to a “document path•file name” area in the same area. Subsequently, the range of the character string indicated by the header part 91 is set as header character string information in a “document profile” area of the same area (S36).

It is checked whether the “process result” area in the “original document” area 22, which shows the result of the content type analyzing process for the header part 91 in step S35, is error (S334). If NO in step S334, it is checked whether the delimiting character string is set in the “delimiting character string” area of the electronic data converting transaction work area 214 (S335). Since, as described above, the content type analyzing process for the header part 91 is normally performed and the delimiting character string “ - - - Boundary - - - ” is already set, the next character string is searched for (S37).

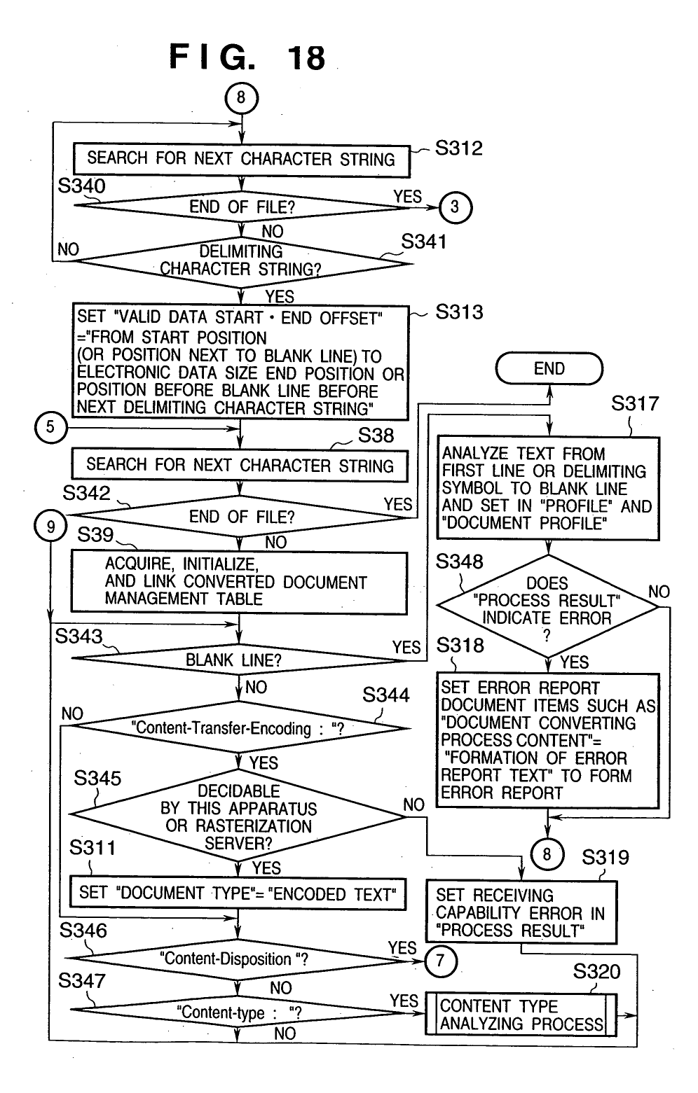

In step S336, whether the next line is “end of file” is checked. Since the next line is the first line of the text part and hence is not “end of file”, the flow advances to step S337 to detect a delimiting character string. Since the first line of the text part 92 is a delimiting character string, the flow advances to step S38 in FIG. 18 to further search for the next character string. The next character string is not the end of the file (S342), so the flow advances to step S39. In step S39, a new document management table 24 for the text part 92 is acquired, initialized, and linked to the end of the document management table 23 already acquired for the header part 91 by using the “next pointer” area of the document management table 23.

Next, a character string “Content-Transfer-Encoding” is searched for (S344), and a character string “Content-Disposition” is searched for (S346), but neither is found. Since “Content-type:” is found (S347), the same content type analyzing process as in step S35 described earlier is performed. A character string following “Content-type:” in the text part 92 is “text/plain;charset=iso-2022-jp”, so the process is executed in the order of S411→S414→S47→S48. “Text” is set in the “document type” area of the document management table 24, and “Japanese S-JIS” is set in the “language type” area. After that, the flow returns to step S343.

The processing from step S343 is repeatedly executed for each line. When the last line of the text part 92 is reached, a blank line (meaning the end of the header information) is detected in step S343, and the flow advances to step S317. This step S317 is analogous to step S36 described above; data in the “electronic data•path•file name” area of the transaction management table 21 is copied to the. “document path•file name” area in the “original document” area of the document management table 24, and header character string information from the start line (“ - - - Boundary - - - ” line) to the last line (blank line)) in the text part 92 is set in the “document profile” area of the “original document” area in the document management table 92. Since the “process result” area in the document management table 24, which indicates the result of the content type analyzing process in step S320, does not contain data indicative of error (S348), the flow advances to step S312 to search for the next character string.

As a result of this search, the first delimiting symbol in the attached file part 93 is detected in step S341. In step S313, the file position of the text part 92 is set in the “valid data start•end offset” area of the “original document” area in the document management table 24.

The flow advances to step S38. Since the next character string is not. “end of file” in step S342, the flow advances to step S39. In step S39, a new document management table 25 for the attached file part 93 is acquired, initialized, and linked to the end of the document management table 24 already acquired for the text part 92 by using the “next pointer” area of the document management table 24. In step S344, the character string “Content-Transfer-Encoding:” is detected. A character string indicating the encoding method, following this character string, is “uuencode” which can be processed by the communication apparatus of the present invention or by the rasterization server apparatus. Therefore, in step S311 “encoded text” is set in the “document type” area of the document management table 25, and the processing is continued. In processing of the next line, “Content-Type:” is detected in step S347, so the flow advances to the content type analyzing process in step S320. Since the character string following “Content-Type:” is “text/plain;” and the subsequent character string is not “charset=”, the analyzing process is terminated only by performing the processing S411→S414, and the flow returns to processing of the next line.

In this embodiment, pieces of information such as encoding methods, extensions, and language types which can be processed by the communication apparatus 148 and by the external rasterization server 1416 are previously stored in the internal nonvolatile storage devices, such as the ROM 2003 and the HDD 2004, of the control unit 2000 of the communication apparatus 148. On the basis of these pieces of information, necessary judgements can be made.

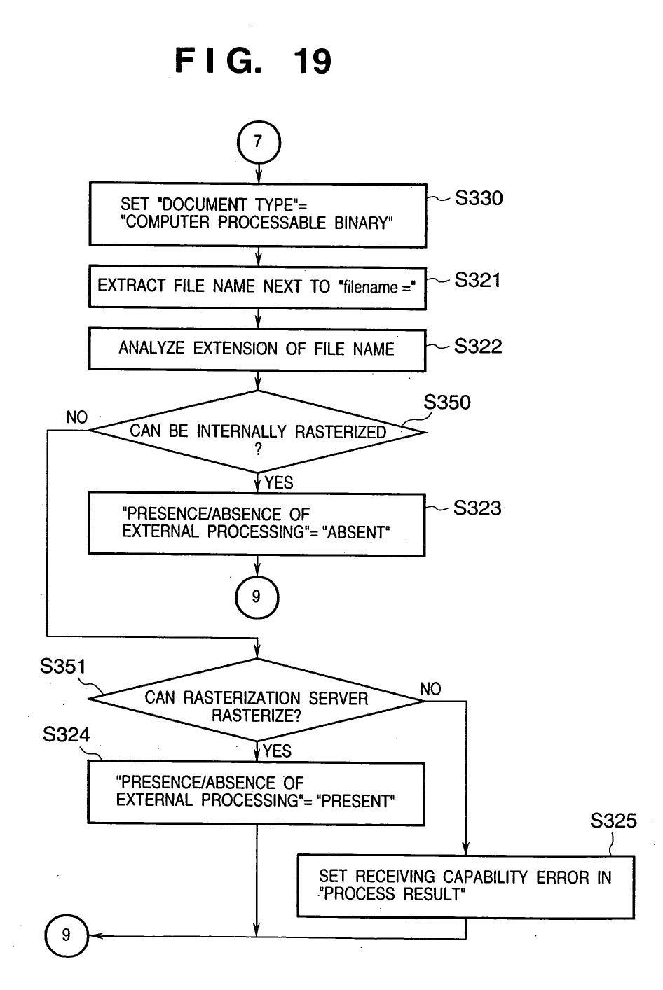

In step S346, “Content-Disposition:” on the fourth line of the attached file part 93 is found. The flow advances to step S330 of FIG. 19 to set “computer processable binary” in the “document type” area of the document management table 25. In step S321, a character string “report.doc” following “filename=” and indicating the file name is extracted. The type of file is analyzed on the basis of the extension and the like of the extracted file name (S322). The extension is “.doc” in the example shown in FIG. 12. In this embodiment, files having this extension “.doc” can be rasterized only by external rasterization servers. Hence, NO is determined in step S350, YES is determined in step S351, and “present” is set in the “presence/absence of external processing” area of the document management table 25 (S324). After that, the flow returns to step S343 in FIG. 18. If the extension “.doc” can be rasterized in the communication apparatus 148, YES is determined in step S350, and the flow returns to step S343 of FIG. 18 to continue processing of the next line. If the extension cannot be rasterized in both the communication apparatus 148 and the rasterization server 1416, NO is determined in step S351, and data indicative of “receiving capability error” is set in the “process result” area of the document management table 25 corresponding to the attached file part 93 (S325). After that, the flow returns to step S343 of FIG. 18 to continue processing of the next line.

When the file “report.doc” converted into text format by uuencode is completely processed, a blank line immediately before the last line of the attached file part 93 is detected in step S343. In step S317, data in the “electronic data•path•file name” of the transaction management table 21 is copied to the “document•path•file name” in the “original document” area of the document management table 25. Also, header character string information from the start line (“ - - - Boundary - - - ” line) to the last line (blank line) of the attached file part 93 is set in the “document profile” area of the “original document” area in the document management table 25. Since the “process result” area in the document management table 25, which indicates the result of the content type analyzing process in step S320, does not contain data indicative of error (S348), the flow advances to step S312 to search for the next line.

In step S341, a delimiting character string of the next line of the attached file part 93 is detected, and the flow advances to step S313. In step S313, the file position of the attached file part 93 is set in the “valid data start•end offset” area of the “original document” area in the document management table 25, and the flow advances to step S38. In step S342, “end of file” is detected, and the electronic data delimiting process is completed.

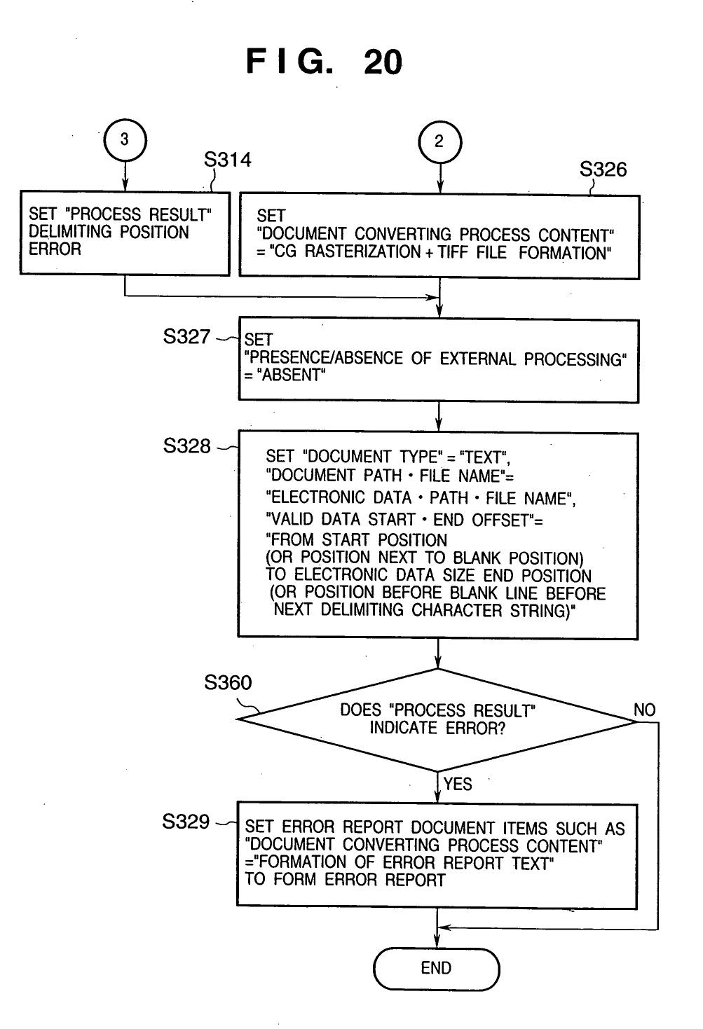

On the other hand, if “end of file” is detected in step S331, the flow advances to step S326 of FIG. 20. “CG rasterization+TIFF file formation” is set in the “document converting process content” area of the “original document” area 22 in the document management table 23 (S326). “Absent” is set in the “presence/absence of external processing” area of the document management table 23 (S327). Additionally, “text” is set in the “document type” area of the table 23, data in the “electronic data•path•file name” area of the transaction management table 21 is copied to the “document•path•file name” area, and “from the start position (or a position next to a blank line) to the electronic data size end position (or a position before a blank line before the next delimiting character string)” is set in the “valid data start•end offset” area (S328) Whether the “process result” area of the table 23 which indicates the content type analyzing process result contains data indicative of error is checked (S360). If no error is found, the document delimiting process is completed.

If “end of file” is detected in step S336 or S340, the flow advances to step S314 in FIG. 20. In step S314, data indicating “delimiting position error” is set in the “process result” area of the corresponding document management table. After that, the processing from step S327 described above is performed.

If the content type analyzing process in steps S35 and S320 terminates with error, data for error report formation is set in the “document converting process content” area of the document management table in step S318, as in step S329. This data is used to form an error report (to be described later).

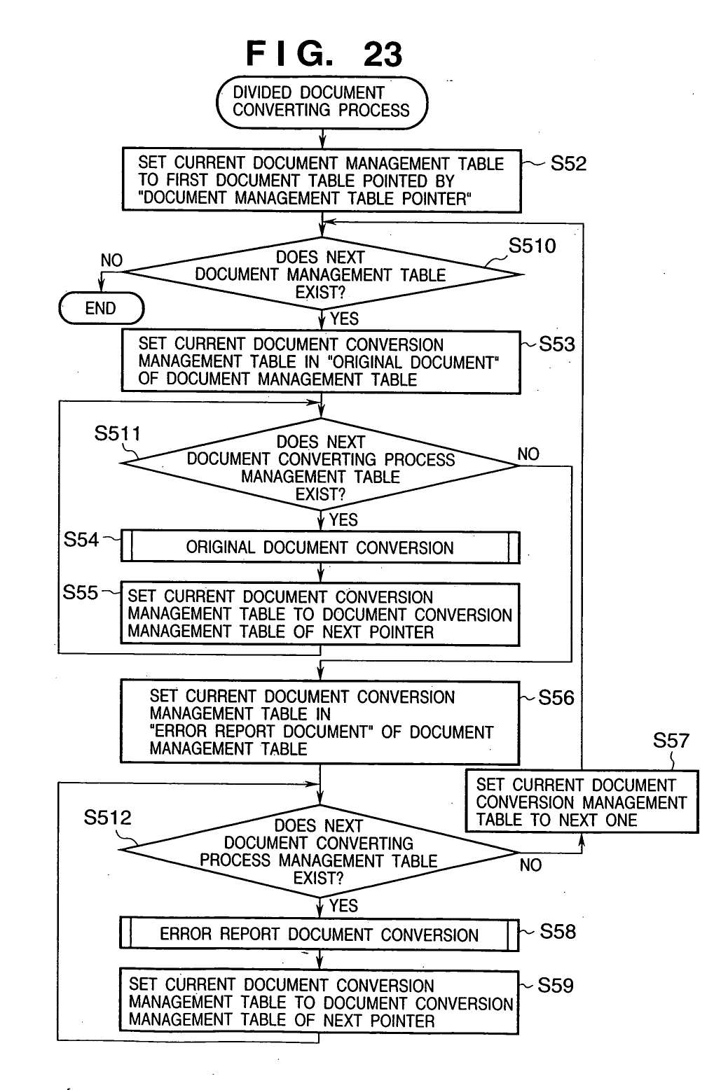

FIG. 23. is a flow chart for explaining details of the divided document converting process explained as step S154 in FIG. 16.

First, in step :S52 a reference point of a current document management table is placed in the start position of the document management table 23, which is indicated by the “document management table pointer” area in the transaction management table 21. Since the next document management table 24 exists, YES is determined in step S510. In step S53, the current document conversion management table is set in the “original document” area of the document management table 23. Since the next document conversion management table 28 exists, YES is determined in step S511, and the flow advances to step S54. In step S54, an original document converting process (to be described in detail later) is performed.

Next, the current document conversion management table is set to the next document conversion management table linked to the original document area 22 in the document management table 23 (S55). The original document converting process in step S54 is repeated to the end of the linked table queue, and the flow advances to step S56. The current document conversion management table is set in the “error report document” area 28 of the document management table (S56), and error report document conversion (to be described later) is performed (S58). This error report document conversion in step S58 is repeated to the end of a document conversion management table queue linked to the “error report document” area 28 by using the next document conversion management table as a reference point. When the table queue is completely processed to the end, NO is determined in step S512, and the reference point of the document management table is switched to the next document conversion management table (S57). When the above processing is completely performed for all document management tables, NO is determined in step S510, and the divided document converting process is completed.

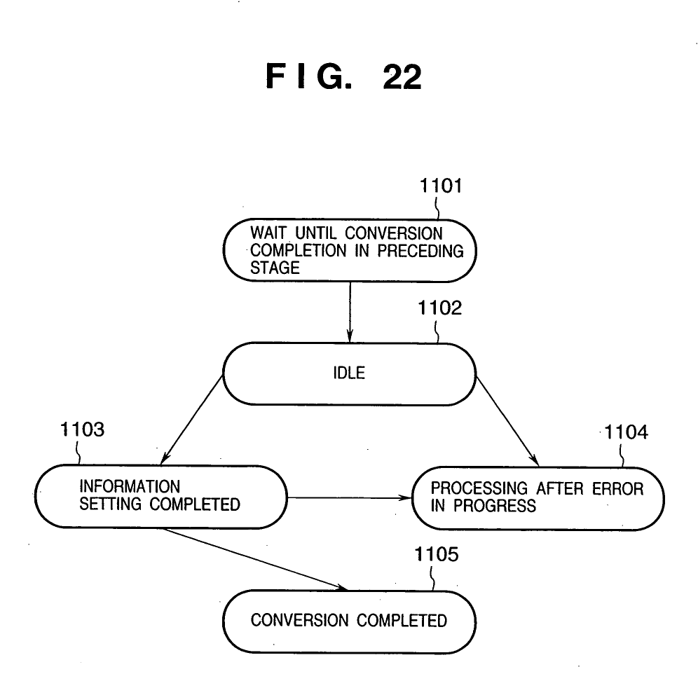

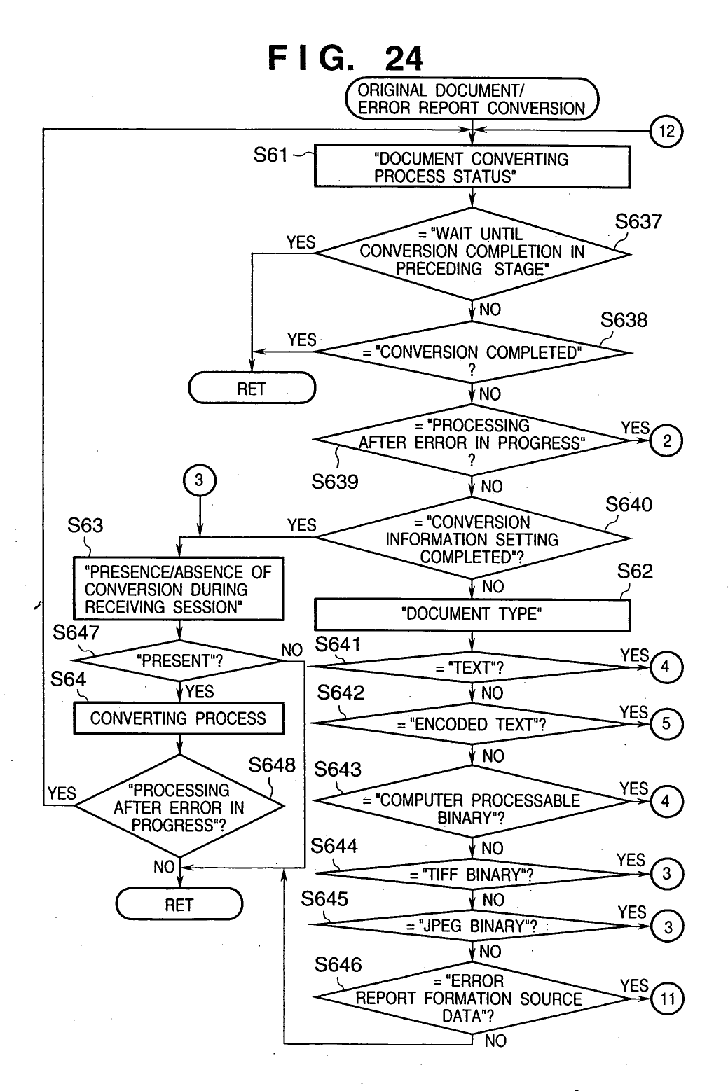

FIGS. 24 to 30, 29, 30, and 31 are flow charts showing details of functions called in the original document converting process (S54) and the error report document converting process (S58) of FIG. 23. Conversion control operates in accordance with the state transition in FIG. 22. The basic control is as follows. Conversion is executed after a document converting process table for output, for storing converted output data, is acquired in each step of the conversion. When the conversion is complete, the converted data at the output is data to be converted by the next conversion, and a document converting process table for outputting that data is secured and linked.

FIG. 22 is a state transition diagram for controlling the divided document converting process shown in FIGS. 24 to 30. The meanings of individual states are as follows:
“Wait until conversion completion in preceding stage (1101)” . . . a state in which completion of a converting process in the preceding stage is waited for.
“IDLE (1102)” . . . a state in which preparations (settings of conversion parameters) for a converting process can be started.
“Information setting completed (1103)” . . . a state in which the preparations (settings of conversion parameters) for the converting process are completed and the control advances to the converting process.
“Conversion completed (1105)” . . . a state in which the converting process is completed.
“Processing after error in progress (1104)” . . . a state in which the converting process terminates with error and a preparing process for “error report” formation as post-processing is being performed.

To more clearly explain the divided document conversion, a divided document converting process executed after the electronic mail data shown in FIG. 12 is received and the electronic data delimiting process shown in FIGS. 17 to 20 and 21 is executed will be described below with reference to FIGS. 23, 24 to 30, 29, 30, and 31.

Prior to the explanation, the connection relationship between management data after the electronic mail data shown in FIG. 12 is received and the aforementioned electronic data delimiting process and content type analyzing process are executed will be described below with reference to the data structure of the electronic data management table shown in FIG. 13.

The header part 91 is linked as the first document management table 23 to the electronic data converting transaction management table 21. “Text”, “ASCII”, and “IDLE” are set in the “document type” area, the “language type” area, and the “document converting process status” area, respectively.

The text part 92 is linked as the second document management table 24 to the document management table 23. “Text”, “Japanese S-JIS”, and “IDLE” are set in the “document type” area, the “language type” area, and the “document converting process status” area, respectively. Also, “present” is set in the “presence/absence of converting process during receiving session” area.

The attached file part 93 is linked as the third document management table 25 to the document management table 24. “Encoded text” is set in the “document type” area.

In step S52 of FIG. 23, a document management table to be processed is set as the first document management table 23 (information in the header part 91 is set). In step S53, the first document converting process management table in the document management table 23 is set as an object to be processed. In step S54, an original document converting process is executed.

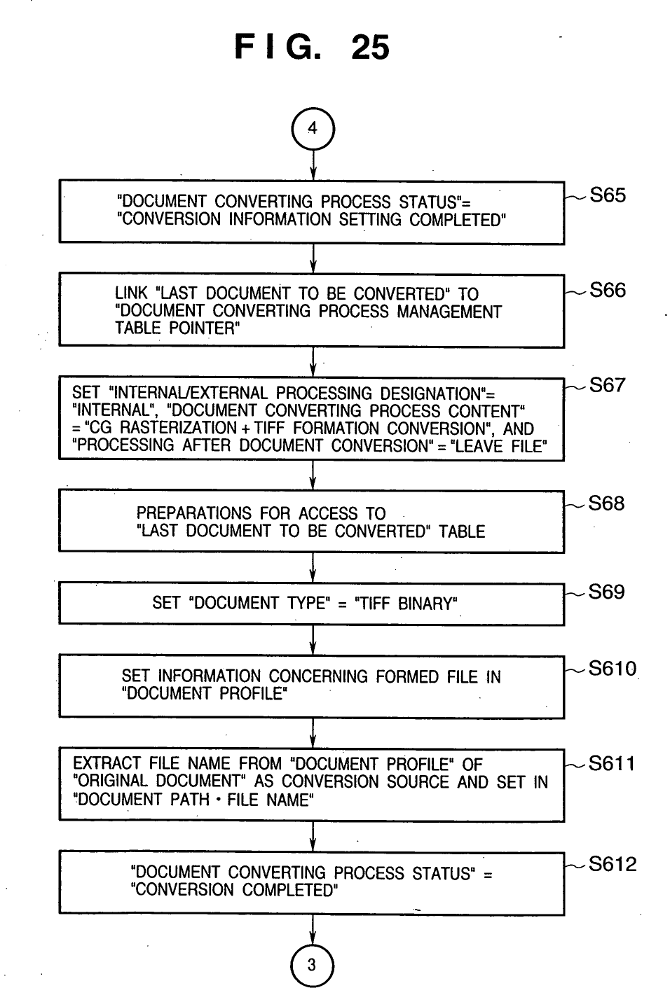

In step S61 of FIG. 24, the “document converting process status” area in the document management table 23 is checked. Since this status is “IDLE”, the flow advances to step S62 without branching in steps S637 to S640, and the “document type” area is checked. Since “text” is set in the “document type” area of the document management table 23, the flow branches from step S641 to step S65 in FIG. 25. In step S65, “conversion information setting completed” is set in the “document converting process status” area of the document management table 23 because parameters necessary for conversion are already set. In step S66, the document converting process management table 29 as the last document to be converted is linked to the “document converting process management table pointer” of the table 23 in order to set document information after conversion. In step S67, parameters such as “internal”, “CG rasterization+TIFF file conversion”, and “leave file” are set in the “internal/external processing designation” area, the “document converting process content” area, and the “processing after document conversion” area, respectively, of the original document area 22.

In step S68, the document converting process management table 29 is set as a table to be processed, the page management table 210 is acquired, and parameters are set. In step S69, “TIFF binary” is set in the “document type” area of the original document area 22. In step S610, parameters to be set in a TIFF file to be formed are set in the “document profile” area of the original document area 22. In step S611, a file (contents are the same as shown in FIG. 12) indicated in the “document path•file name” area as a document profile of the original document area 22, which is an original document of a conversion source, is opened in the “rasterization image file•path•file name ” area of the page management table 210. File seek is performed within the range set in the “valid data start•end offset” area of the original document area 22. For example, a character string “investigation report” following “Subject:” on the third line of the header 91 is used to set a file name “investigation report.tiff” after conversion. In step S612, “conversion completed” is set in the “document converting process status” area of the document management table 23, and the flow returns to step S63 of FIG. 24.

In step S63 (S647), the “presence/absence of conversion during receiving session” area in the original document area 22 is checked. Since “present” is set in this area, a converting process (to be described in detail later) in step S64 is executed to convert from ASCII text into a TIFF image file. The file name after the conversion is “path•file name” (“investigation report.tiff”) set in step S610. If it is determined in step S684 that the converting process terminates normally, the original document converting process (FIG. 23, S54) is completed.

In steps S55 and S511, a document conversion management table to be processed next is searched for. Since no such table exists, the flow advances to step S56. Since no error report document exists either, the flow advances to step S57 to select the document management table 24, which is a document management table for processing the text part 92, as a document management table to be processed next. The processing from step S510 is performed in the same manner as for the header part 91. The document converting process of the text part 92 is the same as the document converting process of the header part 91 except that CG rasterization of Chinese characters is performed, so a detailed description thereof will be omitted.

When the document converting process of the text part 92 terminates normally, the flow advances to step S57 to select the document management table 25 for processing the attached file part 93 as a document management table to be processed next. In step S53, the first document converting process management table in the document management table 25 is set as an object to be processed. In step S54, the original document converting process is performed.

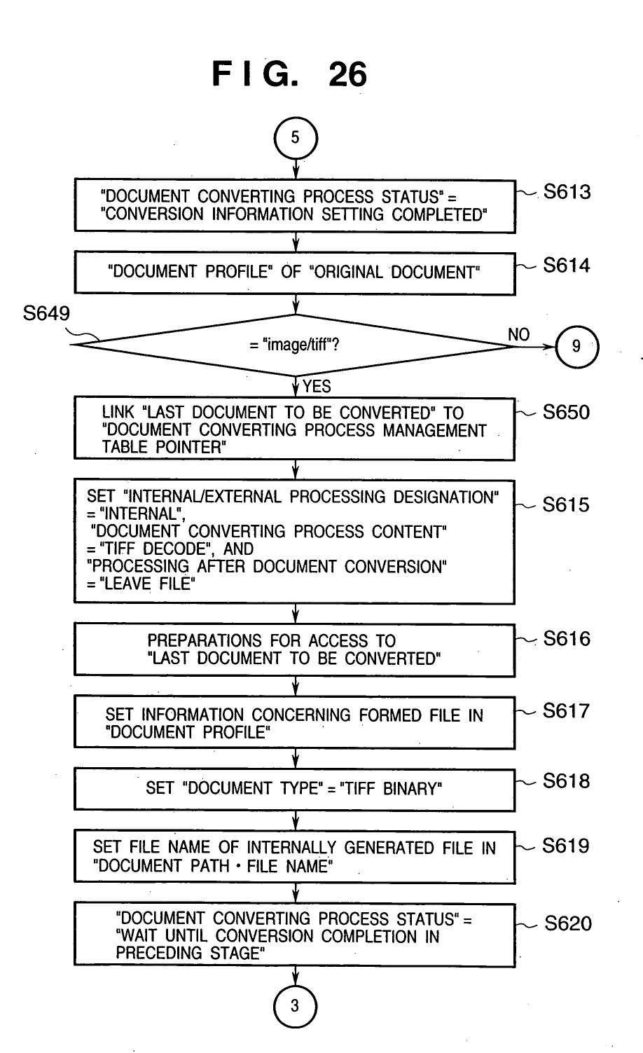

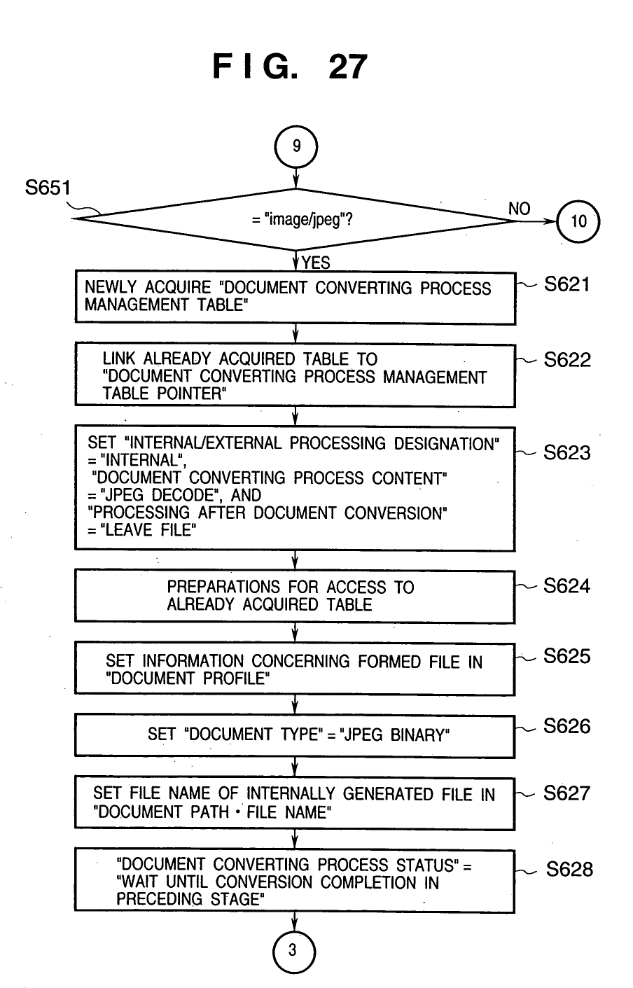

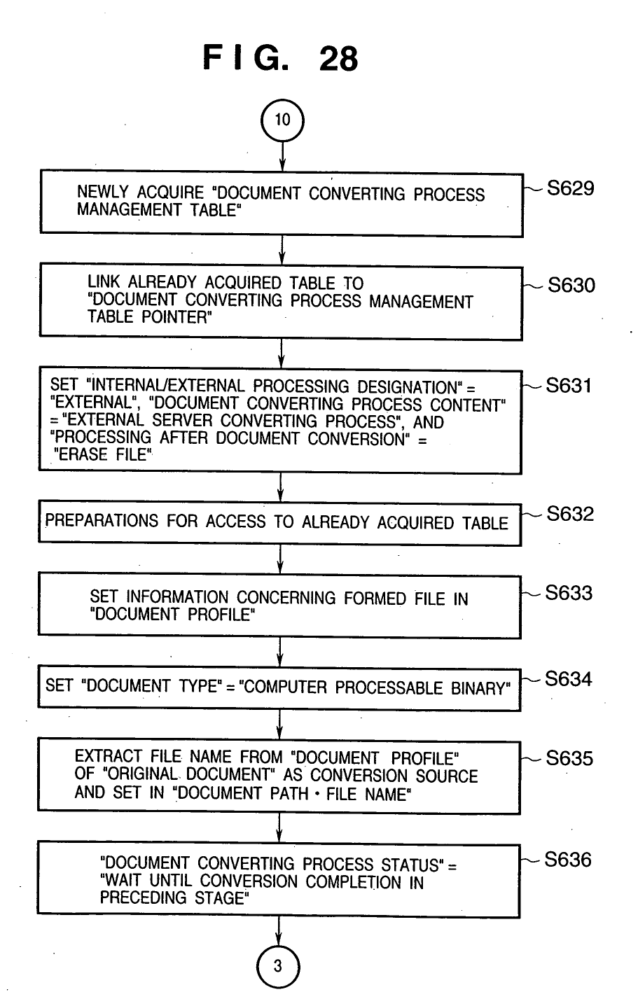

In step S61, the “document converting process status” area in the document management table 25 is checked. Since “IDLE” is set as in the document management table 23, the flow advances to step S62 without branching in steps S637 to S640. Since “encoded text” is set in the “document type” area, the flow branches from step S642 to step S613 in FIG. 26. In step S613, “conversion information setting completed” is set in the “document converting process status” area of the document management table 25. In step S614, “Content-Type:” is retrieved from profile information (from the second line to the fourth line) of the attached file part 93. Since the subsequent character string is “text/plain;”, the flow branches from step S649 to step S651 in FIG. 27. Since NO is determined in step S651, the flow further branches to step S629 in FIG. 28.

In step S629, a new document converting process management table is acquired (not shown). In step S630, this table is linked to the “document converting process management table pointer” area of the document management table 25. Next, parameters such as “external”, “external server converting process”, and “erase of file” are set in the “internal/external processing designation” area, the “document converting process content” area, and the “processing after document conversion” area, respectively, of the acquired document converting process management table (S631). The acquired document converting process management table is initialized (S632), and the document profile information from the second line to the fourth line in the attached file part 93 is set in the “document profile” area (S633). In step S634, “computer processable binary” is set in the “document type” area. In step S635, “report.doc” as a file name is extracted from the “document profile”. In step S630, the extracted file name is set in the “document path•file name” area of the document converting process management table. In step S636, “wait until conversion completion in preceding stage” is set in the “document converting process status” area of this table, and the flow advances to step S63 in FIG. 24. When “wait until conversion completion in preceding stage” is set in the “document converting process status” area, the flow does not proceed to the next processing pertaining to the attached file processing until the converting process in the external server (rasterization server) is complete (for example, processing such as printing is not performed until reception of converted data from the external file server is complete).

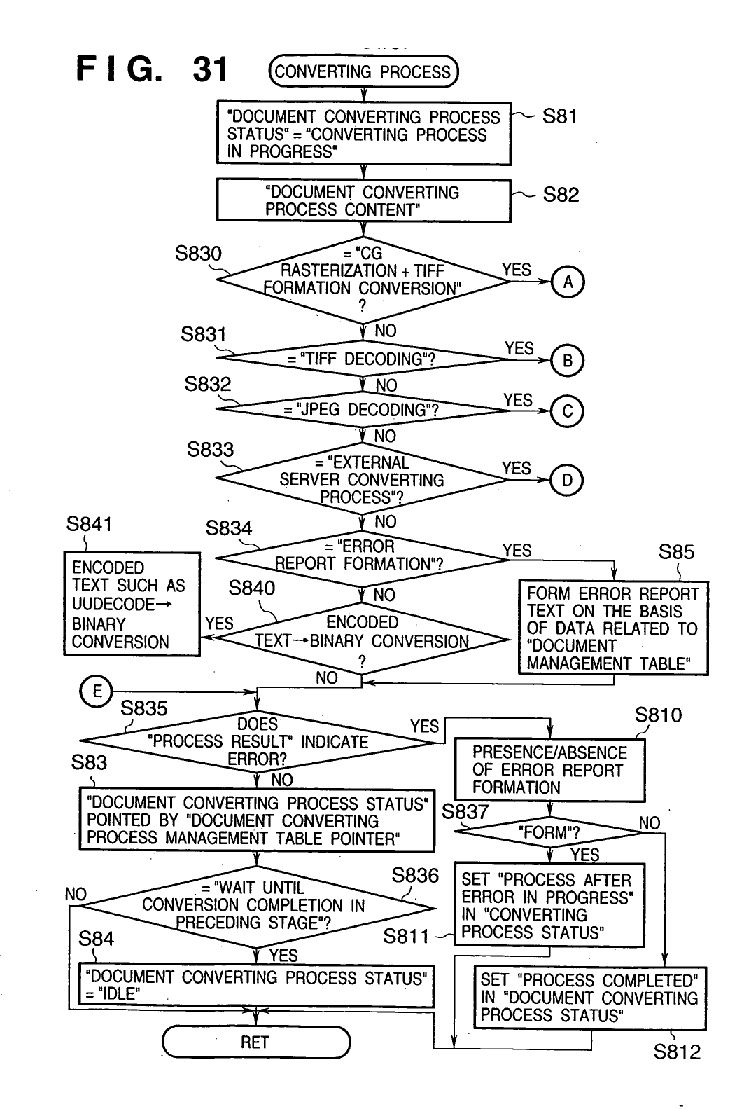

Details of the converting process in step S64 will be described below with reference to FIG. 31. In the following explanation, it is assumed that a character string in the header part 91 shown in FIG. 12 is subjected to CG rasterization and converted into a TIFF image file.

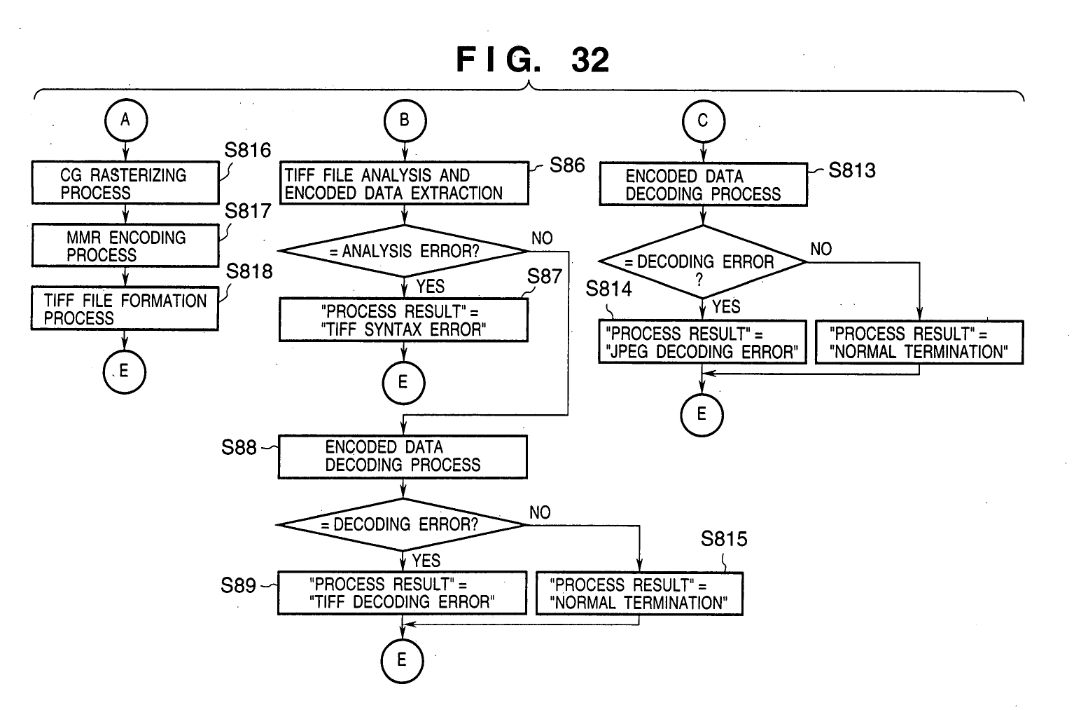

In step S81, “converting process in progress” is set in the “document conversion status” area of the document converting process management table being processed, thereby controlling the flow such that the flow does not advance to the next processing until CG rasterization and TIFF file conversion are complete. Since “CG rasterization+TIFF file formation” is set in the “document converting process content” area of this table, the flow branches from step S830 to step S816 in FIG. 32 to convert a character string in the header part 91 into a bit map image. The image is MMR-compressed (two-dimensionally encoded) in step S817 and converted into a TIFF file in step S818, and the flow advances to step S835 in FIG. 31. If the “process result” area of the table indicates error in step S835, the “presence/absence of error report formation” area in the document converting process management table is checked in step S810. If “form” (an error report) is set in this area, in step S811 “processing after error in progress” is set in the “document converting process status” area of the original document area 22, and the converting process is completed. If “do not form” (an error report) is set, “process completed” is set in the “document converting process status” area, and the converting process is completed.

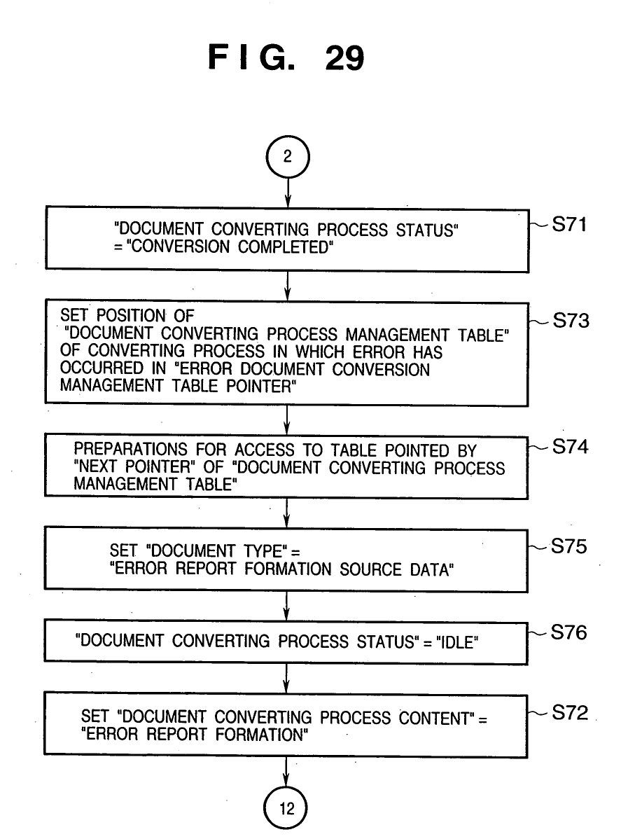

If in step S811 “processing after error in progress” is set in the “document converting process status” area, the flow returns from step S648 to step S61 in the original document/error report converting process shown in FIGS. 24 to 30. The flow further branches from step S639 to step S71 in FIG. 29, thereby advancing to the error report formation process.

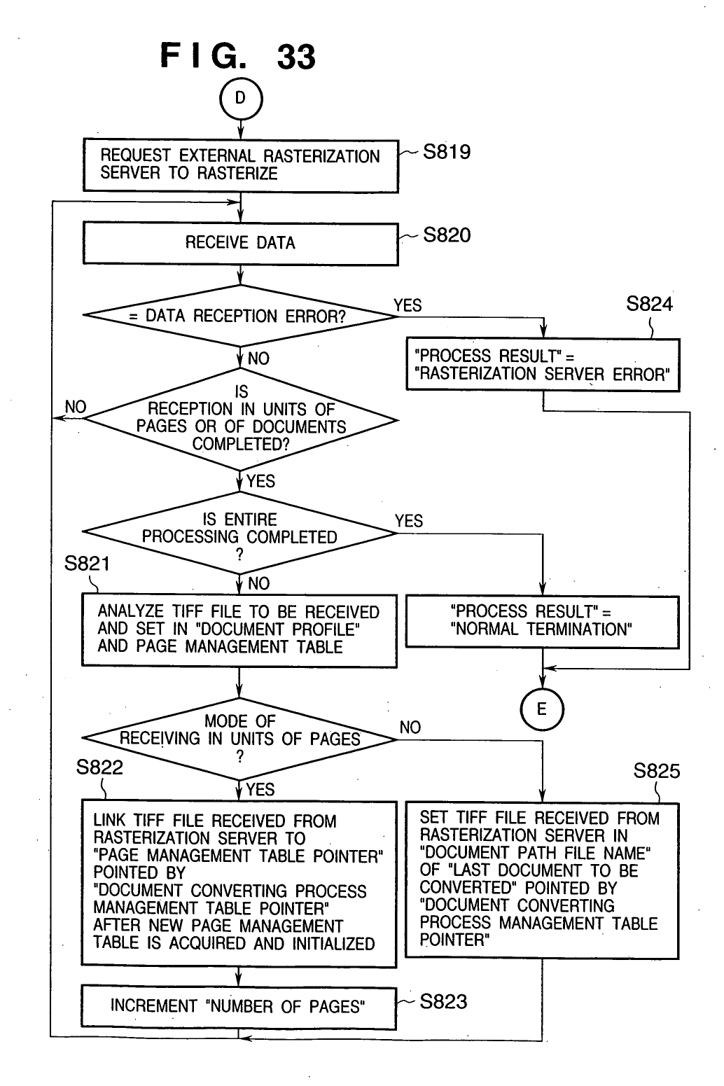

On the other hand, in a converting process of the attached file part. 93 in FIG. 12, the flow branches from step S833 to step S819 in FIG. 33. In step S819, an external server (rasterization server) connected by, e.g., a LAN (Local Area Network) or a telephone line is requested to rasterize. an encoded text as “contents of report.doc converted by uuencode” described in the attached file part 93.

In step S820, a predetermined unit such as one page of data converted from an encoded text into a TIFF file is received from the rasterization server apparatus. If the data is received with no error, in step S821 TIFF file data of the received file is written in a file indicated by “raster image file•path•file name” shown in the page management table. Also, whether the received data is correct is checked. Furthermore, document profile information is extracted from the TIFF file data and stored in the “document profile” area of the document management table, and the received data is decoded to check the presence/absence of error in the received image. If “mode of receiving in units of pages” is “YES”, a page management table is acquired for each page in step S822, and a page management table queue is formed as indicated by 210, 211, and 212. Next, in step S823 “number of pages” in the page management table is incremented. If “mode of receiving in units of pages” is “NO”, the flow advances to step S820 without forming any new page management table in step S825.

Next, processing when reception from the rasterization server 1416 terminates with error while the attached file part 93 is being processed will be described below with reference to FIG. 33. In the data receiving process (S820), error correction for received data is implemented by, e.g., a TCP/IP protocol. However, if an unrecoverable error such as communication timeout occurs, “rasterization server error” is set in the. “process result” area of the document converting process management table area in the document management table 25 (S824), and the flow returns to step S835 in FIG. 31. Since the “process result” area indicates error, the flow branches from step S835 to step S810 to check the “presence/absence of error report formation” area in the “document converting process management table”. If “form” is found, in step S811 “processing after error in progress” is set in the “document converting process status” area. If “do not form” is found, “conversion completed” is set in the same area in step S812. After that, the converting process, i.e., step S64 in FIG. 24 is completed. Processing when “present” is set in the “presence/absence of error report formation” area will be described below.

Since “processing after error in progress” is found in the “document converting process status” area in step S648 of FIG. 24, the flow advances to step S61. In step S61, “processing after error in progress” is found in the “document converting process status”, so the flow branches to step S639 and advances to step S71 in FIG. 29. To form text data of an error report, “conversion completed” is set in the “document converting process status” area. In step S73, to perform an error report text data generating process, the “document converting process management table” address in the “original document” area of the document management table 25 used in the rasterization server processing in which the error has occurred is set in the “error document converting process management table pointer” area of the document management table 25.

In step S74, to reuse the “document converting process management table”, which is used to store the data rasterized by the rasterization server, to form the error report text data, the “document converting process management table pointer” address linked to the “document converting process management table” in the “original document” area of the document management table 25 is set as a currently processed pointer that is to be processed next.

In step S75, “error report formation source data” is set in the “document type” area pointed by the currently processed pointer. In step S76, “IDLE” is set in the “document converting process status” area pointed by the currently processed pointer. In step S72, “error report formation” is set in the “document converting process content” area. In this manner, the error report text data formation process is continued.

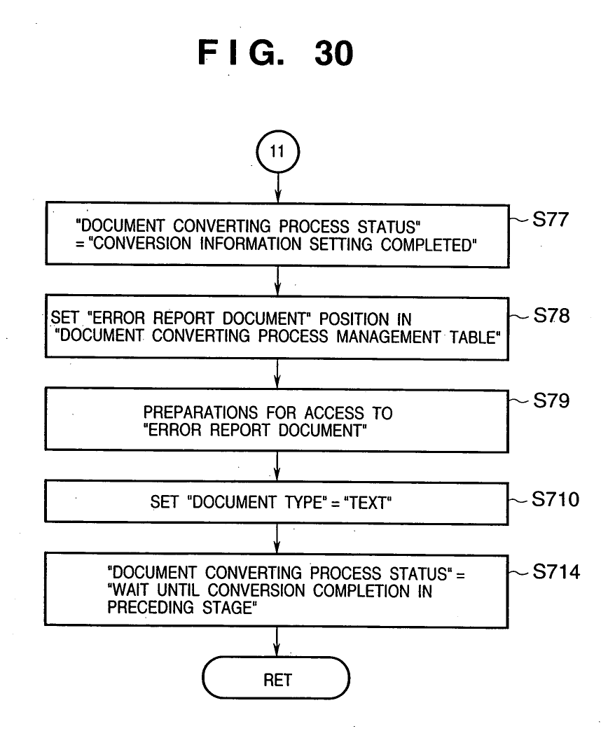

The flow again advances to step S61 in FIG. 24. Since “document converting process status” area pointed by the currently processed pointer contains “IDLE”, the flow does not branch to steps S637 to S640; the flow advances to step S62 to check the “document type” area in the document converting process table 28 of the “error report document” area. Since “error report formation source data” is set in this area in step S75, the flow advances to step S77 (FIG. 30). In step S77, “conversion information setting completed” is set in the “document converting process status” area of the “document converting process table” pointed by the currently processed pointer (in which the “document converting process table” address pointed in the “document converting process table pointer” area of the document management table 25). In step S78, the start address of the “error report document” area in the document management table 25 is set in the “next pointer” area of the “document converting process management table” pointed by the currently processed pointer.

In step S79, the start address of the “error report document” is set in the currently processed pointer. In step S710, “text” is set in the “document type” area of the “document converting process management table” for the error report document, pointed by the currently processed pointer, thereby indicating that error report text conversion is necessary. In step S711, “wait until conversion completion in preceding stage” is set in the “document converting process status” area of the “document converting process management table” pointed by the currently processed pointer. In this way, the original document converting process, i.e., step S54 in FIG. 23 is completed.

Next, in step S55 (FIG. 23) the current document converting process table pointer is updated to the next one. Since no document converting process management table linked to the document management table 25 corresponding to the attached file part 93 exists, the flow does hot branch in step S511; the flow advances to step S56 to make the current document converting process table have the contents of the “error document converting process management table pointer” in the document management table 25. If data is already set in this pointer, this means that an error report document exists, so the flow advances to an error report document converting process (S58).

In this error report document converting process starting from FIG. 24, in step S61 the “document converting process status” area in the current document conversion management table is checked. Since “conversion completed” is already set in step S71 (FIG. 29) as described previously, the flow branches to step S638 to terminate the error report document converting process and returns to step S59 (FIG. 23). In step S59, “document conversion management table” linked next to the current document converting process table is set in the current document converting process table, and the flow again advances to the error report document converting process in. step S58. In the error report document converting process, in step S61 (FIG. 24) the “document converting process status” area in the current document conversion management table is checked. Since “conversion information setting completed” is already set in step S77 (FIG. 30) as described previously, the flow branches from step S640 to step S63. Since no receiving session is currently being executed, the flow advances to step S64 to execute the converting process (FIG. 31).

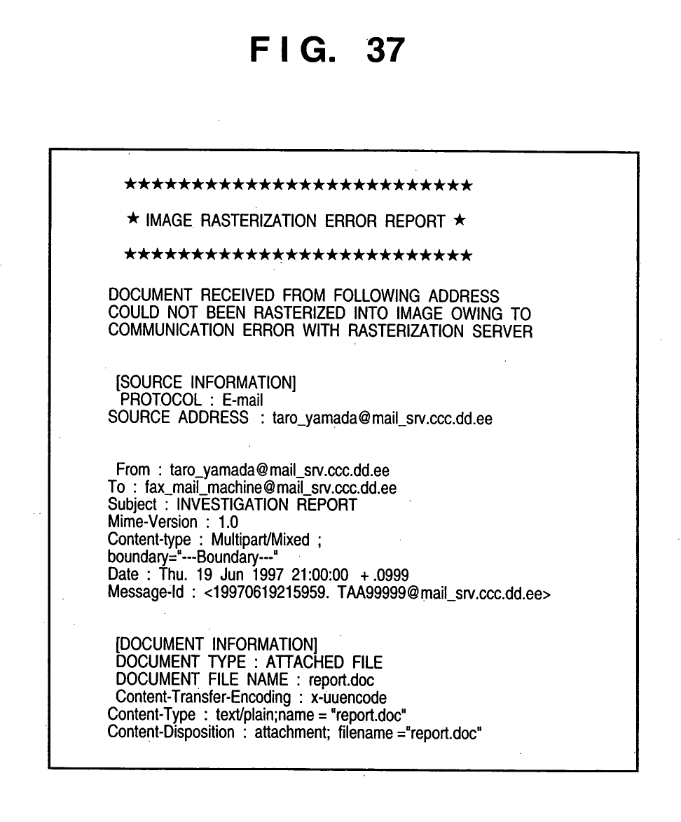

In this converting process, in step S81 “conversion in progress” is set in the “document converting process status” is set in the current document converting process table. In step S82, “document converting process content” area is checked. Since “error report formation” is already set in this area in step S72 (FIG. 29) as described above, the flow branches from step S834 to step S85. “Japanese S-JIS” is set in the “document type” area of the current document management table in the content type analyzing process (FIG. 21, S47). Also, it is determined that the “process result” in the “document converting process table” indicated by the “error document converting process management table pointer” area in the current document management table is “rasterization server error” (already set in step S824 (FIG. 33)). Accordingly, text data of an error report such as shown in FIG. 37 is generated by Shift-JIS character codes and written as a text file of “document path•file name” in the current document converting process table (S85).

Since the text generating process is normal, the flow does not branch in step S835 to check the “document converging process status” area in the “document converting process table” linked to the “next pointer” area in the current document converting process table (S83). If the content is “wait until conversion completion in preceding stage”, YES is determined in step S836. After that, “IDLE” is set in this area (S84), and the converting process is completed.

Since the converting process (S64) shown in FIG. 24 is completed and the “document converting process status” area is not “processing after error in progress”, the error report converting process is completed, and the flow advances to step S59 in FIG. 23. In step S59, the current document converting process table is set to the “document converting process table” linked to the “next pointer” area in the current document converting process table. Since the next table exists, YES is determined in step S512, and the error report converting process is again executed in step S58. The contents of the current document converting process table are the same as the contents set in step S710 (FIG. 30); “text” is set in the “document type” area. Processing from this point is identical with the aforementioned processing for the header part 91, so a detailed description thereof will be omitted.

The foregoing is the processing when error occurs in communication with the rasterization server. If error is detected when the rasterization server is rasterizing source data, the rasterization server generates an error report described above and transmits as an image file to the communication apparatus of this embodiment. Alternatively, the rasterization server informs the communication apparatus of error information, and the communication apparatus generates an error report.

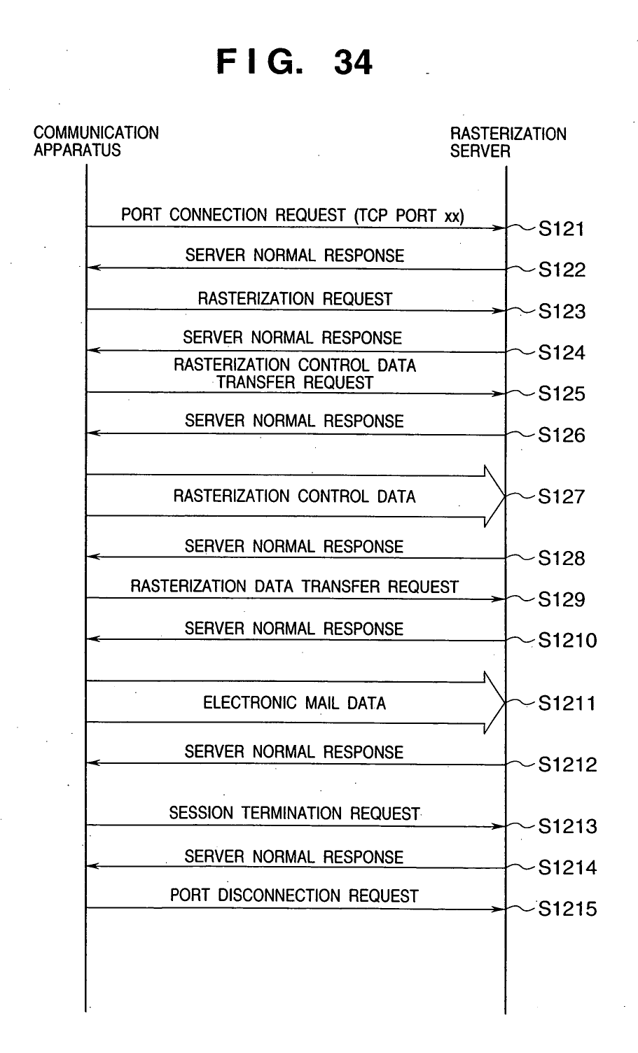

FIG. 34 is a protocol sequence view showing a rasterization request used in step S819 of FIG. 33 to request an image rasterization server 1418, connected via the LAN 2011 (or the WAN 2051), to rasterize data that cannot be rasterized in the communication apparatus 148 of the present invention. In this embodiment, TCP/IP is used as the protocol.

First, the communication apparatus of the present invention associates, by using TCP/IP, with the rasterization server apparatus by a port number (xx) corresponding to a demon process of rasterization (S121). Next, the rasterization server apparatus responds (S122) to start a document rasterization request session. The communication apparatus sends a “rasterization request” command to the rasterization server apparatus (S123) to request the server to start the rasterizing process session.

The communication apparatus receives a response from the rasterization server apparatus (S124) and, in order to report information “rasterization control data” pertaining to data requested to be rasterized, sends a “rasterization control data transfer request” to the rasterization server apparatus (S125). After receiving a normal response from the server (S126), the communication apparatus transmits the rasterization control data (S127). As this rasterization control data, pieces of information such as “language type”, “paper size for image rasterization” (e.g., A4 or B4), “form one file by a plurality of pages of raster images in image rasterization” or “form one file by one page”, and “reception number” are transferred.

When completing the transmission of the rasterization control data and receiving a normal response from the server (S128), the communication apparatus transmits a rasterization data transmission request command to the server (S129). After receiving a response from the server (S1210), the communication apparatus transmits electronic mail data (attached file data) as rasterization data on the basis of information recorded in a predetermined area of the management table (FIG. 13) (S1211). This rasterization data transmitted is a “computer processable binary” file converted (decoded) from text to binary data. If a plurality of attached files required to be rasterized exist, the steps from the sending of the rasterization control data transfer request command (S125) are repeated. This makes transmission of data in one session possible. After completing the transmission of the electronic mail data, the communication apparatus receives a normal response from the server (S1212). If no more file to be rasterized (to be transmitted) exists, the communication apparatus sends a “session termination request” command to the rasterization server apparatus (S1213). After receiving a normal response from the server (S1214), the communication apparatus transmits a port disconnection request (S1215) to terminate the session.

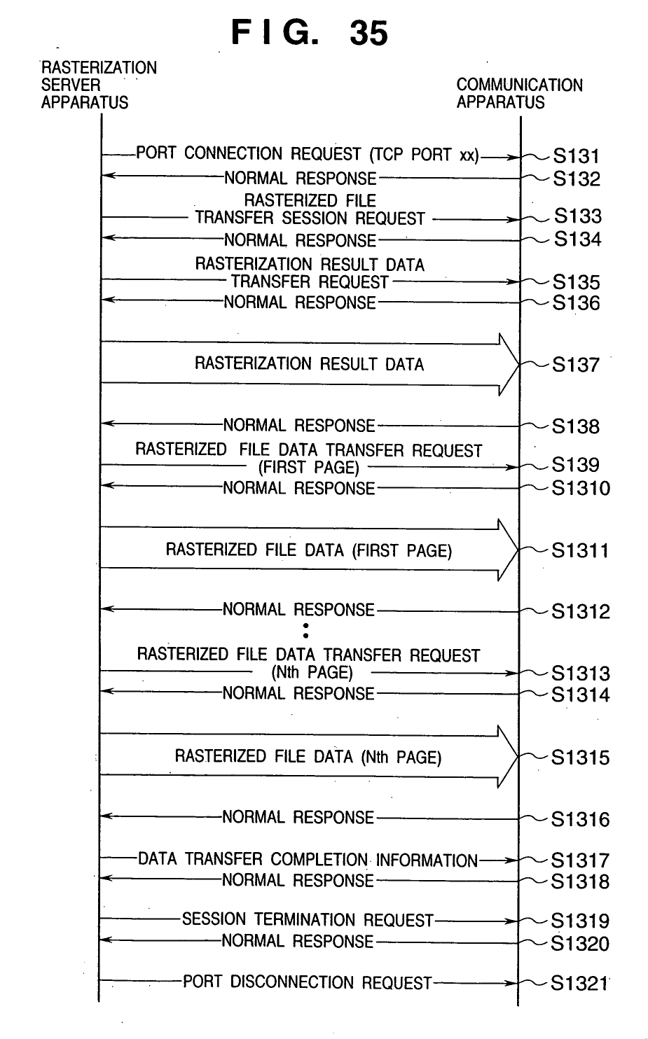

FIG. 35 shows a rasterized document transfer protocol sequence used to send raster image data from the image rasterization server 1416 to the communication apparatus 148. TCP/IP is used as when the communication apparatus requests rasterization. Assume that the image rasterization server has already received “form one file by one page” rasterization control data from the communication apparatus.

The rasterization server apparatus 1416 associates, by using TCP/IP, with the communication apparatus 148 by a port number (xx) corresponding to a demon process of rasterized document reception operating on the communication apparatus (S131). Upon receiving a response from the communication apparatus (S132), the server transmits a “rasterized file transfer session start request” command (S133). The communication apparatus normally responds to this command (S134) to start a rasterized document transfer session.

First, the rasterization server apparatus transmits a “rasterized document transfer request” command (S135). When receiving this command, the communication apparatus prepares for reception, e.g., acquires a memory and table for reception, and returns a response (S136). Upon receiving the response, the server transmits “rasterization result data” such as “reception number” and “rasterizing process result” (S137). Of the received rasterization result data, the communication apparatus sets necessary data in a predetermined area of the management table (FIG. 13) and returns a response (S138).

The rasterization server apparatus transmits a “rasterized file data transfer request” command for the first page (S139). The communication apparatus sets information concerning a file to be transmitted, obtained from this command, into a predetermined area of the management table and returns a response (S1310). Upon receiving this response, the server transmits file data (first page) rasterized into TIFF binary (S1311). In this embodiment, “form one file by one page” is set when rasterization is requested. Therefore, the communication apparatus stores the received file in the HDD 2004 or the like. The communication apparatus also stores management information in the page management table 210 linked to the page management table pointer area in the “last document to be converted” area 29 of the document management table 23, and returns a response (S1312).

Subsequently, the server and the communication apparatus execute steps S139 to S1312 for a file of the second page. The communication apparatus stores management information of this second-page file in the page management table 211. The same processing is repeatedly performed for the remaining pages. Transfer request (S1313) and file data transmission (S1315) are similarly performed for the last (Nth) page. The communication apparatus normally responds after reception (S1316), and the rasterization server apparatus transmits a “data transfer completion information” command (S1317). The rasterization server apparatus receives a normal response from the communication apparatus (S1318) and confirms that transmission of all pages terminates normally. If no more rasterized document exists, the server transmits a “session termination request” command (S1319). To transmit a plurality of documents, the steps from the transmission of the “rasterized document transfer” command (S135) to S1318 are repeated. When the communication apparatus receives the “session termination request” command and returns a normal response (S1320), the rasterization server apparatus transmits a “port disconnection request” command to terminate the session.

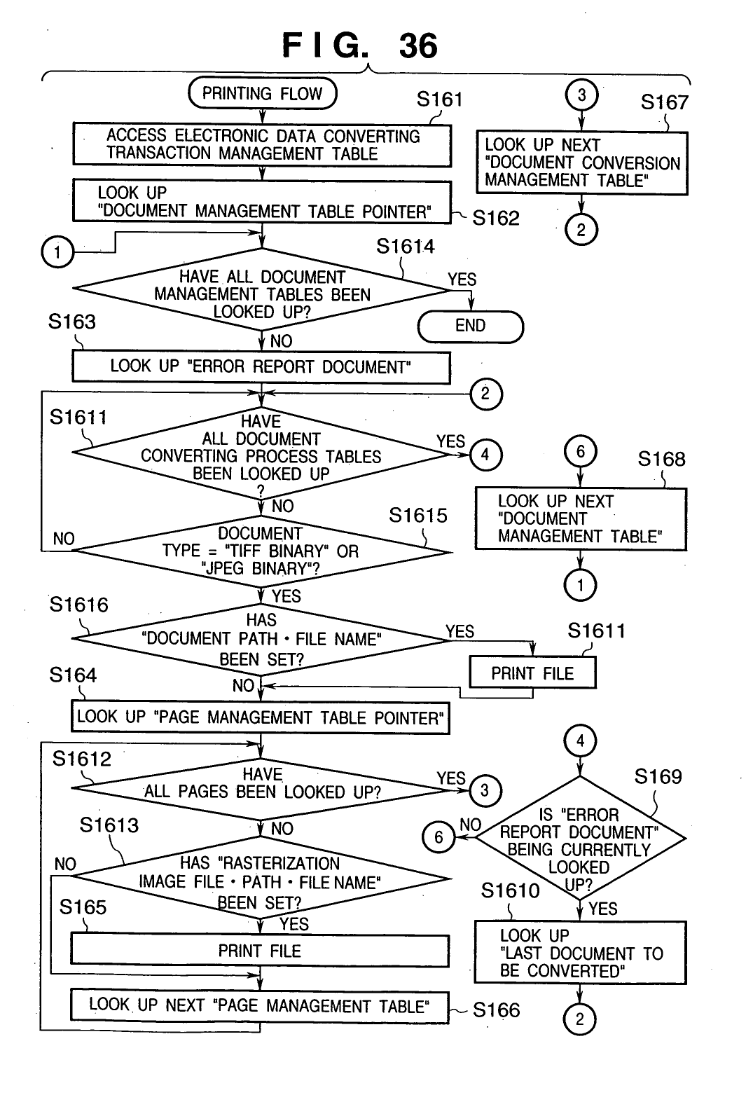

FIG. 36 is a printing process flow chart for performing control, after received electronic data is converted into image data printable by the printing device of the communication apparatus of the present invention, so that the image data does not mix with other printing data in units of pages.

First, the electronic data converting transaction management table 21 (FIG. 13) storing received data and used in various converting processes is looked up (S161). A “document management table” linked to the “document management table pointer” area of this table is set as a current document management table (S162). In step S1614, whether all document management tables have been looked up is checked. If YES in step S1614, the processing is terminated; if not, in step S163 the “error report document” area in the “document management table” is looked up as a current document converting process table. Whether all document converting process tables in the current document management table have been looked up is checked (S1611). If YES in step S1611 and no error report document is being looked up (S169), the flow advances to step S168 to set the current document management table to the contents of the “next pointer” area in the table, and returns to step S1614.

On the other hand, if an error report is currently being looked up, the “last document to be converted” area in the current document management table is set as the current document converting process table as a document to be printed (S1610), and the flow advances to step S1611. Since not all document converting process tables have been completely looked up, the “document type” area in the current document converting process table is looked up to check whether the document is “TIFF binary” or “JPEG binary” (S1615). If the document is one of these two types, whether the “document path•file name” area in the current document converting process table has been set is checked (S1616). If this area has been set, the file is printed (S1617).

If the area has not been set, in step S164 the “page management table pointer” in the current document converting process table is set as the current page management table, and whether all pages have been looked up is checked (S1612). If all pages have been looked up, in step S167 the next current document conversion management table is set to the next one, and the flow advances to step S1611.

If not all pages have been looked up in step S1612, the “rasterization image file•path•file name” area in the current page management table is checked (S1613). If this area has not been set, the flow advances to step S166; if YES, the set file is printed in step S165. In step S166, the contents of the “next pointer” in the current page management table are set in the table, and the flow advances to step S1612. In this manner, the printing process is completed through processing of all pages in document conversion management table processing of all document management tables processing of all document management tables.

[Other Embodiments]

In the above embodiment, the present invention is applied to a hybrid machine having a copying function and a FAX function. However, the present invention can be applied to a system constituted by a plurality of devices (e.g., a host computer, interface, reader, and printer) or to an apparatus (e.g., a copying machine or facsimile apparatus) comprising a single device.

Further, the object of the present invention can also be achieved by providing a storage medium storing program codes of software for performing the aforesaid functions according to the embodiments to a system or an apparatus, reading the program codes with a computer (or a CPU or MPU) of the system or apparatus from the storage medium, and then executing the program.

In this case, the program codes read from the storage medium realize the functions according to the embodiments, and the storage medium storing the program codes constitutes the invention.

Further, as the storage medium for providing the program codes, it is possible to use, e.g., a floppy disk, hard disk, optical disk, magnetooptical disk, CD-ROM, CD-R, magnetic tape, nonvolatile memory card, and ROM.

Furthermore, besides aforesaid functions according to the above embodiments are realized by executing the program codes which are read by a computer, the present invention includes a case where an OS (Operating System) or the like running on the computer performs a part or the whole of actual processing in accordance with designations by the program codes and realizes functions according to the above embodiments.

Furthermore, the present invention also includes a case where, after the program codes read from the storage medium are written in a function extension board which is inserted into the computer or in a memory provided in a function extension unit which is connected to the computer, a CPU or the like contained in the function extension board or unit performs a part or the whole of actual processing in accordance with designations of the program codes and realizes functions of the above embodiments.

When the present invention is applied to the above storage medium, this storage medium stores program codes corresponding to the aforementioned flow charts. For example, a module capable of realizing the flow chart shown in FIG. 16 is stored in the storage medium.

As has been described above, the communication apparatus of the present invention can rasterize an electronic data document such as a word processor document or a spreadsheet document and output the rasterized data as image data. This releases the user of a PC from a series of complicated operation procedures of once converting a document into image data to form a TIFF file and attaching this TIFF file to electronic mail. That is, the user can easily send a desired word processor document or spreadsheet document from the PC by simply attaching the document using electronic mail software.

Also, a word processor document or a spreadsheet document is transferred to this communication apparatus without being rasterized into a TIFF file. Therefore, the data capacity is smaller than that of a TIFF-file, so the data can be reliably transmitted to the communication apparatus.

Furthermore, the language type of source is detected, and an error report described in that language is transmitted if error occurs. This allows the user to correctly recognize the contents of the error.

The communication apparatus of the above embodiment is, of course, applicable to an apparatus constructed of a plurality of devices such as a computer, a scanner, and a printer.

Although the above embodiments have been described in conjunction with the SMTP protocol, this invention is not limited to this aspect but another electric mail protocol is applicable to send or receive electric mail data.

The above embodiment can also be achieved by supplying programs to a system or an apparatus. If this is the case, the objects of the present invention are achieved by a computer (CPU or MPU) of the system or the apparatus by reading out and executing program codes stored in the storage medium to achieve the present invention.

When the computer is to execute the readout program codes, a module provided by an OS (Operating System) running on the computer can also perform a part of the processing.

As many apparently widely different embodiments of the present invention can be made without departing from the spirit and scope thereof, it is to be understood that the invention is not limited to the specific embodiments thereof except as defined in the appended claims.

1-72. (canceled)

73. A communication apparatus comprising:
a receiving unit adapted to receive electronic mail;
an extracting unit adapted to analyze the electronic mail received by said receiving unit and to extract binary data attached to the electronic mail;
a converting unit adapted to convert the binary data extracted by said extracting unit into image data;
a determining unit adapted to determine a language type used by a sender from header information of the electronic mail transmitted from the sender and received by said receiving unit;
a generating unit adapted to generate an error report electronic mail indicating a conversion error by a message written in a language corresponding to the language type determined by said determining unit; and
a transmitting unit adapted to transmit the error report electronic mail to the sender.

74. The communication apparatus according to claim 73, wherein said determining unit determines the language type based on information, in header information of the electronic mail, specifying a character code.

75. The communication apparatus according to claim 73, wherein said extracting unit includes a content dividing unit adapted to divide, by using MIME header information, received electronic information composed of a character code into a character code portion and a binary data portion converted into the character code.

76. A communication method comprising the steps of:
receiving an electronic mail;
extracting binary data attached to the electronic mail by analyzing the electronic mail received in the receiving step;
converting the extracted binary data into image data;
determining a language type used by a sender from header information of the electronic mail transmitted from the sender and received in the receiving step;
generating an error report electronic mail indicating a conversion error by a message written in a language corresponding to the language type in the determined step; and
transmitting the error report electronic mail to the sender.

77. A communication apparatus comprising:
a receiving unit adapted to receive data sent from a remote sender;
a data processing unit adapted to process the data received by said receiving unit;
a content analyzing unit adapted to detect a language type of the data;
a report information generating unit adapted to generate information, relating to the result from said data processing unit, described by the language type detected by said content analyzing unit; and
an information transmitting unit adapted to transmit the information generated by said report information generating unit to the remote sender.

78. The communication apparatus according to claim 77, wherein said content analyzing unit is also adapted to determine whether said data processing unit is capable of processing the language type detected.

79. A data communication method comprising the steps of:
receiving data sent from a remote sender;
processing the data received in said receiving step;
detecting a language type of the data;
generating information relating to a result obtained in said processing step described by the language type detected in said detecting step; and
transmitting the information generated in said generating step to the remote sender.
